(19) United States
(12) Patent Application Publication
(10) Pub. No.: US 2008/0154762 A1
(43) Pub. Date: Jun. 26, 2008

(54) METHOD OF TRADING CLIENT LEADS

(75) Inventors: Donald S. Campbell, Royal Oak, MI (US); Anik Ganguly, Northville, MI (US)

Correspondence Address: GIFFORD, KRASS, SPRINKLE,ANDERSON & CITKOWSKI, P.C, PO BOX 7021, TROY, MI, 48007-7021, US

(73) Assignee: Detroit Trading Company, Royal Oak, MI (US)

(21) Appl. No.: 11/941,482

(22) Filed: Nov. 16, 2007

Related U.S. Application Data
(60) Provisional application No. 60/866,100, filed on Nov. 16, 2006.

(51) Int. Cl. G06Q 30/00; G06F 17/00

(52) U.S. Cl. 705/37

(57) ABSTRACT

A system and method of trading of leads may include an automated exchange where leads are traded at market value. In the exchange, buyers and sellers may agree to be bound by uniform trading rules, so that sales may be quickly and efficiently made. Sellers of leads deliver lead information to the exchange administrator. The exchange administrator may receive this lead information from seller in a number of different ways. The exchange administrator may then use a variety of means to deliver basic information about the lead to one or more lead buyers along with current pricing information. The basic lead information may include a person's zip code and a few other facts. Interested buyers may then bid on the lead based upon the basic lead information and with the current pricing. The lead may then be sold to the buyer who best matches the seller's criteria.

### CROSS-REFERENCE TO RELATED APPLICATIONS

This Application is a Non-Provisional application of Provisional (35 USC 119(e)) application 60/866,100 filed on Nov. 16, 2006.

### FIELD OF THE INVENTION

Disclosed herein is an embodiment of a system and method for the exchanging/trading of sales leads. More particularly, the disclosed method and system are directed to an exchange for the automated buying and selling of sales lead information.

### BACKGROUND OF THE INVENTION

Leads for business opportunities are frequently collected by one party and then sold to a second party. In many cases these leads are highly time sensitive, with the lead's usefulness and value being measured in terms of hours. Indeed, auto finance leads may have a different value from one time of day to the next time of day.

Current mechanisms for selling leads have often involved the use of written contracts drawn between the parties. These contracts may have prices specified in an addendum to the one-off contractual agreement. However, when a price changes, it may be necessary to change the contracts thereby making such trades cumbersome and expensive.

Accordingly, it would be desirable to provide a system for trading/exchanging sales leads quickly and effectively.

### SUMMARY OF THE INVENTION

Disclosed herein is an embodiment of system and method of exchanging leads that permits the trading of leads at market value and eliminates the need for individual contracts between buyers and sellers. Participants, however, may retain control over the parties with whom they wish to do business. In the exchange, buyers and sellers may agree to be bound by uniform trading rules, so that sales may be quickly and efficiently made. Sellers may deliver sales lead information to the automated exchange administrator using a variety of electronic portals and means. The sales lead information may include a person's zip code, gross monthly income, and a few other facts. The exchange administrator may then deliver a portion of the sales lead information and current pricing information to buyers in several ways. Interested buyers may then submit bids to the exchange administrator based upon the portion of the lead information provided to them and the current pricing. The complete lead may then be posted to the buyer whose bid best matches the seller's criteria. Price may be the only criterion.

### BRIEF DESCRIPTION OF THE DRAWINGS

Reference will now be made to the attached drawings wherein like reference numerals refer to like parts throughout, and wherein:

FIG. 1 is a diagrammatic view of an embodiment for system for exchanging lead information;

FIG. 2 is a XML code printout of a sample lead to be exchanged;

FIG. 3 is printout of a front end webpage for an embodiment of an exchange administrator;

FIG. 4 is a printout of a login webpage for an embodiment of an exchange administrator;

FIG. 5 is a printout of a summary webpage for a seller account for an embodiment of an exchange administrator;

FIG. 6 is a printout of a buyer/seller relationship webpage a seller account for an embodiment of an exchange administrator;

FIG. 7 is a printout of a state sales summary webpage on a seller account for an embodiment of an exchange administrator;

FIG. 8 is a printout of a summary webpage for a buyer account for an embodiment of an exchange administrator;

FIG. 9 is a printout of a buyer/seller relationship webpage for a buyer account for an embodiment of an exchange administrator;

FIG. 10 is a printout of a market order summary webpage for a buyer account for an embodiment of an exchange administrator;

FIG. 11 is a printout of a geographic area selection webpage for a market order for a buyer account for an embodiment of an exchange administrator;

FIG. 12 is a printout of a order filter and delivery webpage for a market order for a buyer account for an embodiment of an exchange administrator

FIG. 13 is a printout of a price assistance, lead capacity and pricing webpage for a market order for a buyer account for an embodiment of an exchange administrator

FIG. 14 is a printout new market order review webpage for a buyer account for an embodiment of an exchange administrator; and

FIG. 15a-15t are an embodiment of uniform rules of trading participant agreement for use in connection with buyer and seller accounts for and embodiment of an exchange administrator.

### DETAILED DESCRIPTION

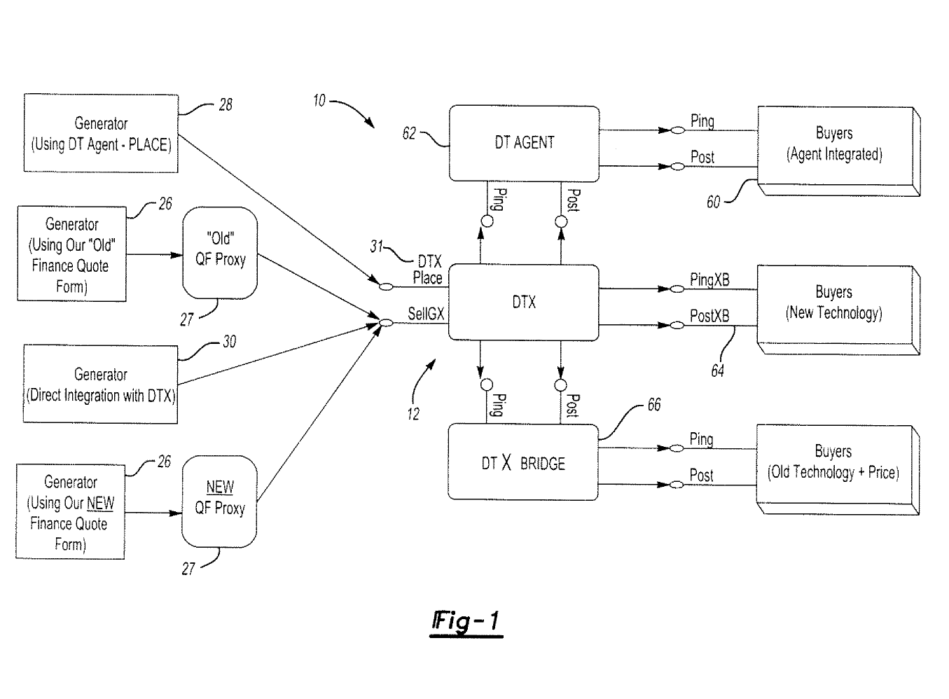

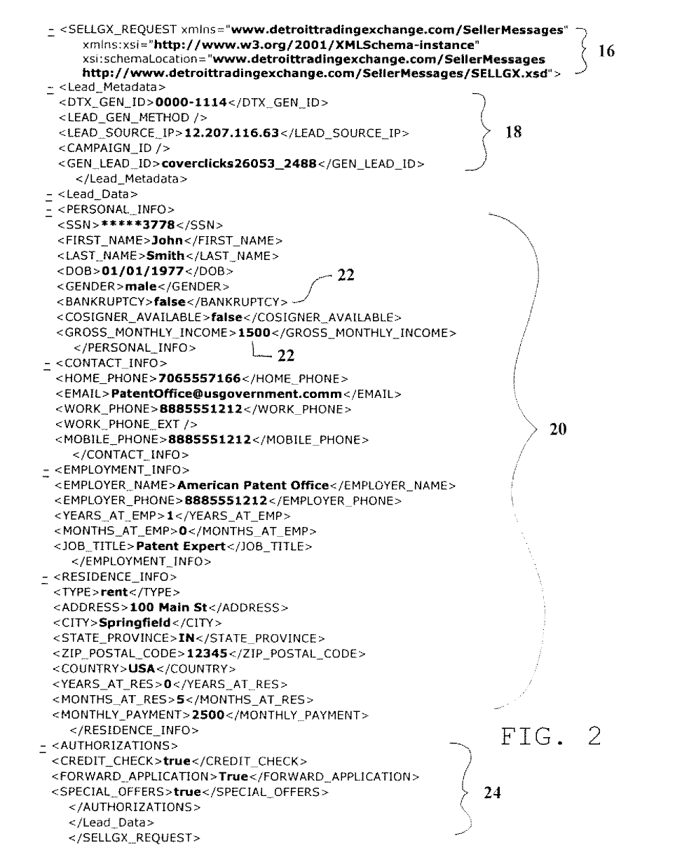

Referring now to FIGS. 1 and 2, there is shown a system and method for exchanging/trading lead information 10. The system may include an automated lead exchange administrator 12 having a memory, data storage and/or database for storing and maintaining one or more seller/generator accounts and one or more buyer/aggregator accounts. The exchange administrator 12 may also include one or more data processors that operate to receive process and transmit lead information 14 between the buyer accounts and the seller accounts. Further, as will be described below, the seller and buyer accounts may each be subject to a set of uniform rules of trading that facilitate the rapid and efficient exchange of leads.

Still referring to FIG. 1, it will be appreciated that the exchange administrator 12, with its buyer and seller accounts, data storage, processors, etc., may be formed or otherwise constructed of one or more commercially available computer servers, including an internet web server, and a plurality of HTML or similar web pages. Lead information may be transmitted between accounts, both on and physically remote from the exchange administrator using standard web protocols and XML representation.

Referring now to FIGS. 1 and 2, lead information 14 may related a person interested in purchasing or financing a new or used vehicle. However, it will be appreciated that all manner of lead information 14 may be exchanged using the disclosed system and method 10. For example, lead information may include (but not be limited to) general business leads, professional referral leads (e.g., doctors, dentists), mortgage leads home construction/improvement leads, furniture purchase leads, home purchase leads, retail services leads, etc. Further, as best shown in FIG. 2, a lead may include personal and financial information about a person who may be interested in purchasing a particular product or service (e.g., obtaining financing for a vehicle). The sale lead information may also typical include information about the lead seller and how/where the lead originated. More specifically, each lead may include: 1) routing information 16 to electronically guiding the lead into the exchange; 2) lead metadata 18 (e.g., IP address of lead source, seller identification); 3) personal information 20 about the lead (e.g., name, address, date of birth, social security number (partial), gender, contact information, employer information); 4) personal financial information (e.g., bankruptcy status, credit status, monthly income); and 5) whether the lead has provided certain authorizations 24 such as a credit check, bankruptcy check or the like.

Referring now to FIGS. 1 and 2, a seller(s) may secure new sales lead information using a number of different avenues, and then forward that collected information to the exchange administrator 12. FIG. 1, for example, shows three different mechanisms for a lead seller to submit lead information for sale to the exchange administrator 12. First, a seller may use an HTML coded quote form 26, 26′ to collect and submit leads. The seller may post these HTML forms on one or more remote internet websites, and then solicit the person(s) that visit the site(s) to fill out and submit the form. As shown in FIG. 1, the forms may be submitted to the exchange administrator 12 using a software compatibility protocol known as SELLGX. Different versions of the form (see 26, 26′) may be available to accommodate different types of lead sellers or the different software or hardware requirements of the seller.

Second, sales lead information may be transferred to the exchange administrator 12 from a seller through a “Place” 29 protocol resident in the DT Agent software 28, and through the DTX Place 31 protocol resident on or associated with the exchange administrator 12. The DT Agent Place and DTX Place protocols may each be a web services call using standard XML representation. DT Agent is itself a commercially available software system designed by the Detroit Trading Company. DT Agent created a nexus for sellers and buyers of sales lead information using predetermined prices. Thus, with the “Place” protocols, persons using the “older” DT Agent system may continue to use the same protocols and messages to submit leads to the more dynamic marketplace offered by the exchange administrator 12. Therefore, it will be appreciated that one of the particularly novel features of the disclosed system and method for exchanging/trading sales lead information 10 is that it also backward compatible with the older contract/fixed price technology (such as DT Agent). For example, as just mentioned, different proxy servers/protocols 27, 27′ may be used to allow for forward/backward compatibility between the exchange administrator 12 and the quote forms 26, 26′. Further, the two “Place” protocols may operated to permit the smooth follow and exchange of data between what would otherwise be two dissimilar formats and/or terminals (e.g., the exchange administrator 12 or DT Agent).

Third, a seller may log into 30 and work directly through the exchange administrator 12. Further, as shown in FIG. 2 the sales lead information may be collected or otherwise formatted into Extensible Markup Language (XML) (or similar code). As such, the lead information may be easily transmitted into and between seller account and buyer accounts on the exchange administrator 12 and/or transmitted to remote third party applications from the exchange administrator 12.

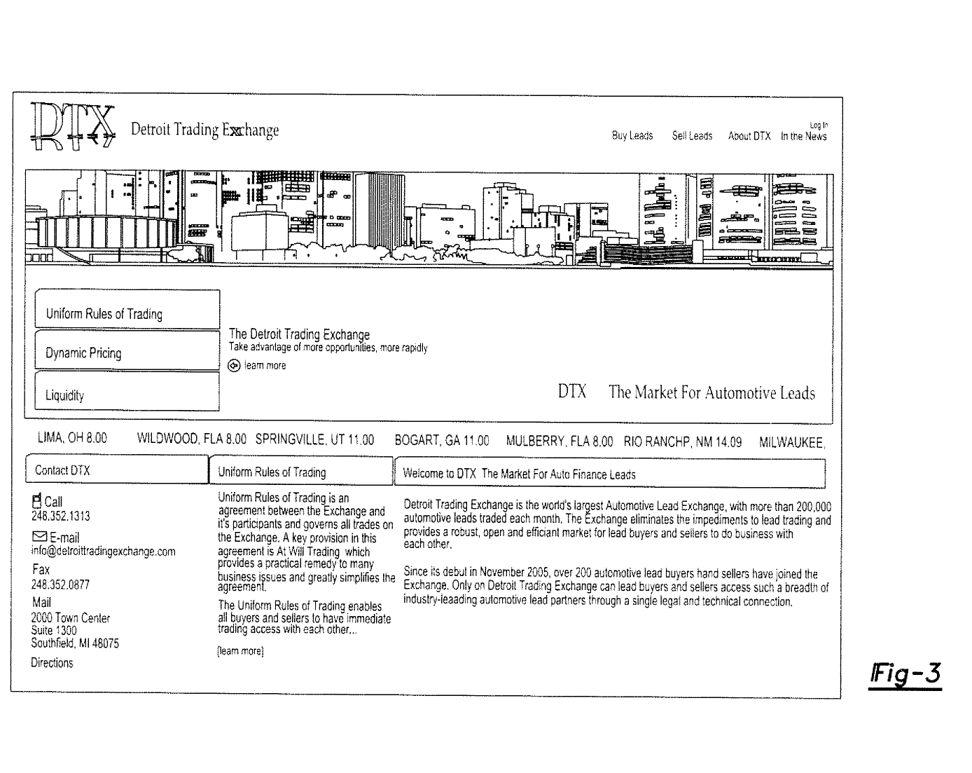

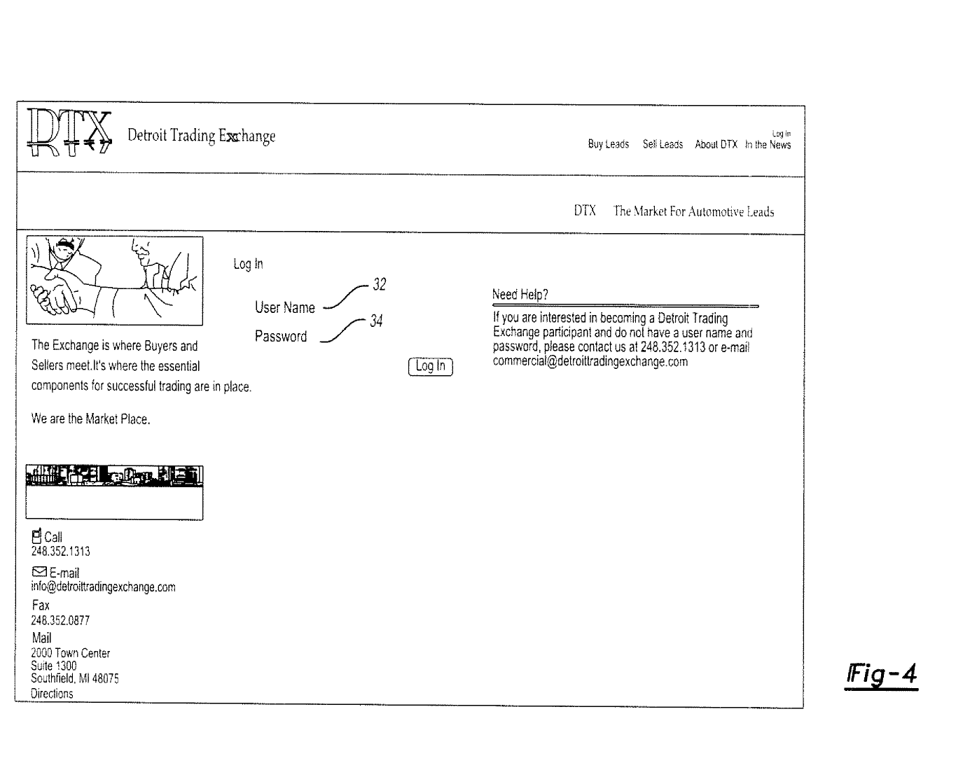

Referring now to FIGS. 3 through 7, as mentioned supra, each seller of sales lead information may have a seller account resident on the exchange administrator 12. Further, each seller account, and also the exchange administrator 12, may be accessed through a front end resource, such as an internet website (FIG. 3). Specifically, a seller may first access a front end website for the exchange administrator 12 and then log into the exchange administrator 12 using a recognized username 32 and password 34 (see FIG. 4).

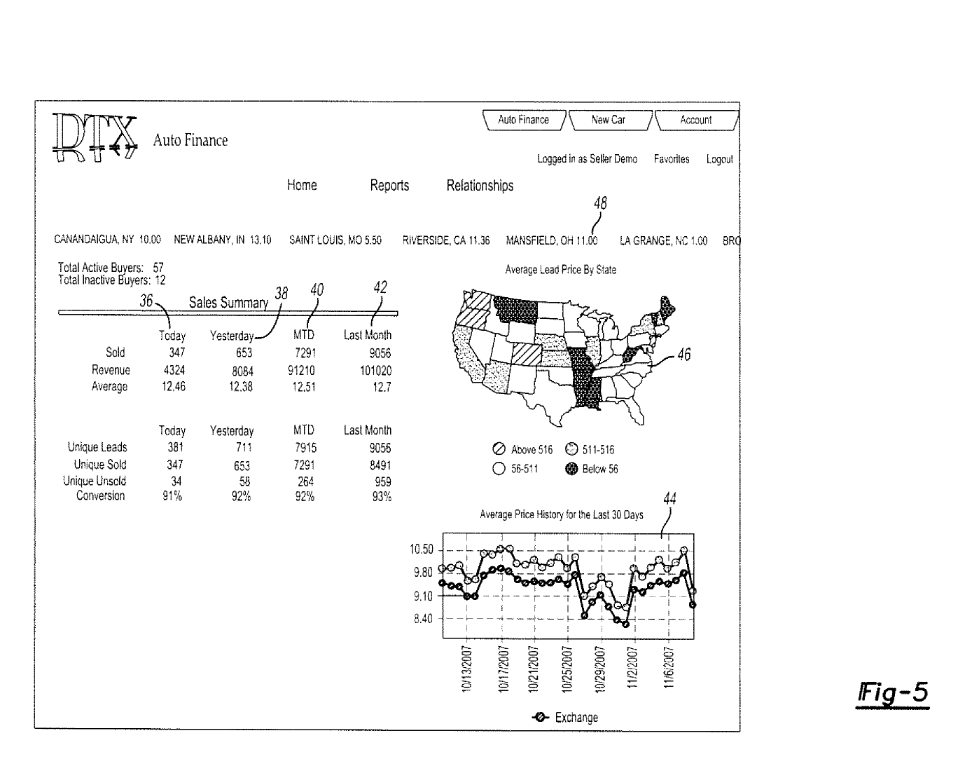

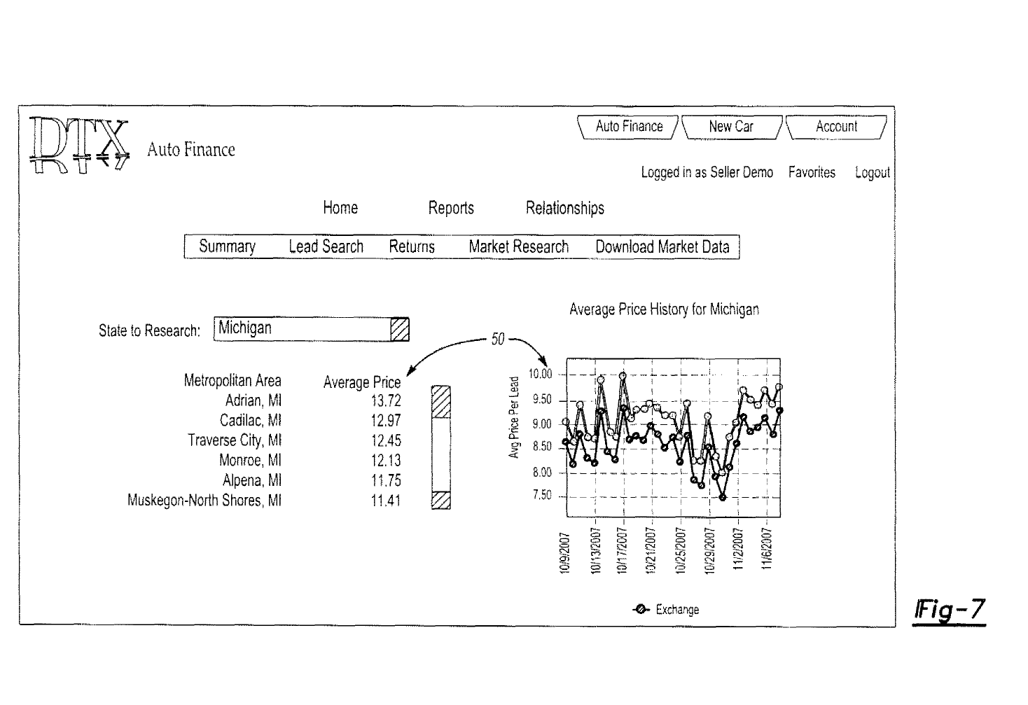

Still referring to FIGS. 3 through 7, a seller, upon accessing the exchange administrator 12 may be provided with the seller's overview screen (FIG. 5.). The overview screen may include a summary of that seller's past sale of lead information and related information from the exchange administrator 12. The overview screen may, for example, feature 1) a seller's lead sales data for the current day 36, the prior day 38, the month to date 40 and prior months 42; 2) current and historical average prices 44 for all sales of lead information nationwide on the exchange administrator 12; 3) a map 46 showing price ranges for recent sales of lead information on a state by state basis; and 4) a sales ticker 48 showing the geographic location and price of recent sales of lead information. As best shown in FIG. 7, selecting a state on the map may also provide a seller with lead sales information 50 specific to that state. Additionally, each seller account may be provided with: 1) current and historical lead information; 2) market research data for all leads sold on the exchange; and 3) information concerning leads that were returned to the seller account from a buyer due to invalid lead information (e.g., inaccurate contact information). Each seller account may also include personal profile for the seller. The personal profile may include the seller's business and contact information. Each seller may also receive accounting reports that detail the seller's prior sales of lead information to a buyer.

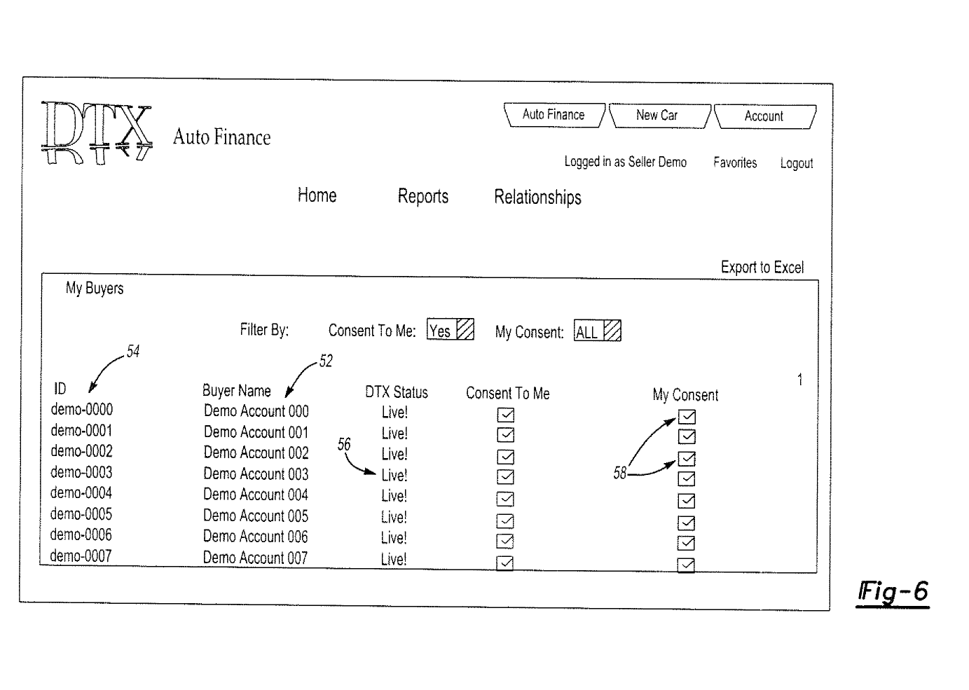

Still referring to FIGS. 3 through 7, and a best shown in FIG. 6, each seller may customize the seller's relationship with buyers of lead information. Specifically, a seller account may be customized by the seller so that sale lead information is, or is not, offered to a particular buyer on the exchange administrator 12. As shown in FIG. 6, each seller account may include a listing 52 of each buyer account on the exchange administrator 12 and a link 54 to that buyer's personal profile. This same list may also indicate whether the buyer is currently active 56 on the exchange. Each seller must then indicate in a check box 58 associated with each buyer account whether the seller will agree to offer to sell new lead information to each particular buyer. If a seller does not consent to a particular buyer, any new lead information that is subsequently submitted to the exchange administrator 12 by that seller will not be offered to the excluded buyer by the exchange administrator 12. However, if a seller does agree to a particular buyer, and that buyer (as will be explained further below) also consents to accept offers from the seller, then new lead information that is subsequently submitted to the exchange administrator 12 by the seller will be forwarded to that particular buyer.

Referring again to FIG. 1, like sellers, buyers/bidders on sales lead information may also have different ways in which they can interact with the exchange administrator 12. First, buyers who were already integrated with the DT Agent 60 and offered predetermined prices may link 62 to the exchange administrator 12. Specifically, as mentioned above with regard to sellers, the exchange administrator 12 or an associated server may perform the task of communicating with the DT Agent interface by translating between the different protocols and messages, as well as from the predetermined pricing to the dynamic pricing mechanism. As such, the exchange administrator 12 may function to ensure that each offer (a “PING”—see below) and its related sale lead information are accurately transmitted to buyers, and the buyers' responses are correctly interpreted and acted on. Second, buyers may use the protocol and messages 64 (PINGXB and POSTXB) specified by the exchange administrator 12 to interact directly with the exchange administrator 12 and receive the full benefit of optional capabilities. Third, buyers may specify their own custom protocol and message that the exchange administrator 12 may use for communication of PING and lead data—this is accomplished using the DTX Bridge interface 66. DT or DTX Bridge is a communication/translation software platform developed by Detroit Trading Company that permits buyers and sellers using otherwise incompatible software platforms to communicate buy and sell orders to one another. As shown in FIG. 1, the DTX Bridge may be used to allow buyers having an otherwise incompatible platform to effectively communicate with the exchange administrator 12.

In view of the above, it will be appreciated that the disclosed method for exchanging/trading sales lead information 10 may be backward compatible with older contract/fixed price technology (such as DT Agent) that may be used by some buyers. As such, these buyers (like the sellers mentioned supra) may integrate their older technology and methods for purchasing lead information into the present method and system 10 so that they too may participate in a dynamic market based system of bidding on and purchasing lead information. For example, as just mentioned, buyers using older technology may customize the interface between the buyer's system and the exchange administrator 12 through the DTX Bridge interface 66 (i.e., a web services call using standard XML representation).

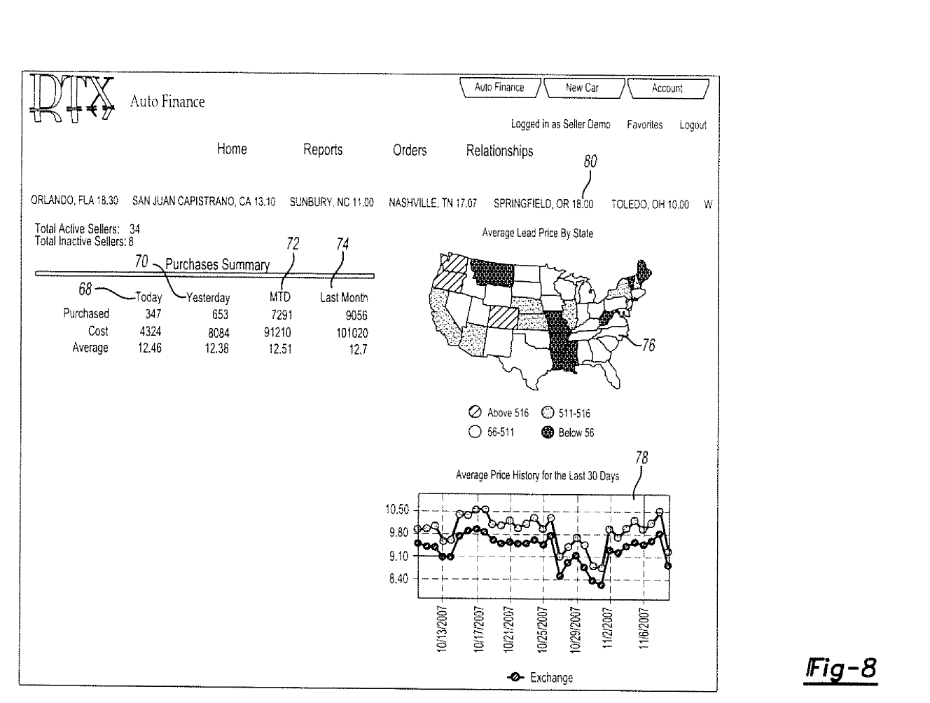

Referring now to FIGS. 3, 4, 8 and 9, each buyer of lead information may have a buyer account resident on the exchange administrator 12. Like the seller accounts, each buyer, and also the exchange administrator 12, may be accessed through a front end resource, such as an internet website (FIG. 3) and by providing a recognized username 32 and password 34 (See FIG. 4). Once accessed, the buyer's account may be of similar design to that of the seller. The buyer's account may, for example, include an overview screen (FIG. 8) having a summary of that buyers purchases of lead information and related information from the exchange. The overview screen may also feature: 1) a seller's lead sales data for the current day 68, the prior day 70, the month to date 72 and prior months 74; 2) current and historical average prices 76 for all sales of lead information nationwide on the exchange administrator 12; 3) a map 78 showing price ranges for recent sales of lead information on a state by state basis; and 4) a sales ticker 80 showing the geographic location and price of recent sales of lead information. As is the case with the seller map (see FIG. 7), selecting any state on the map may also provide the buyer with sales information specific to that state. Additionally, each buyer account may be provided with: 1) current and historical lead information; 2) market research data for all leads sold on the exchange; and 3) information concerning leads that were returned to a seller account from the buyer due to invalid lead information (e.g., inaccurate contact information). Each buyer account may also include personal profile for the buyer. The personal profile may include the buyer's business and contact information. Each buyer may also receive accounting reports that detail the buyer's prior purchase of lead information from sellers over the exchange administrator 12.

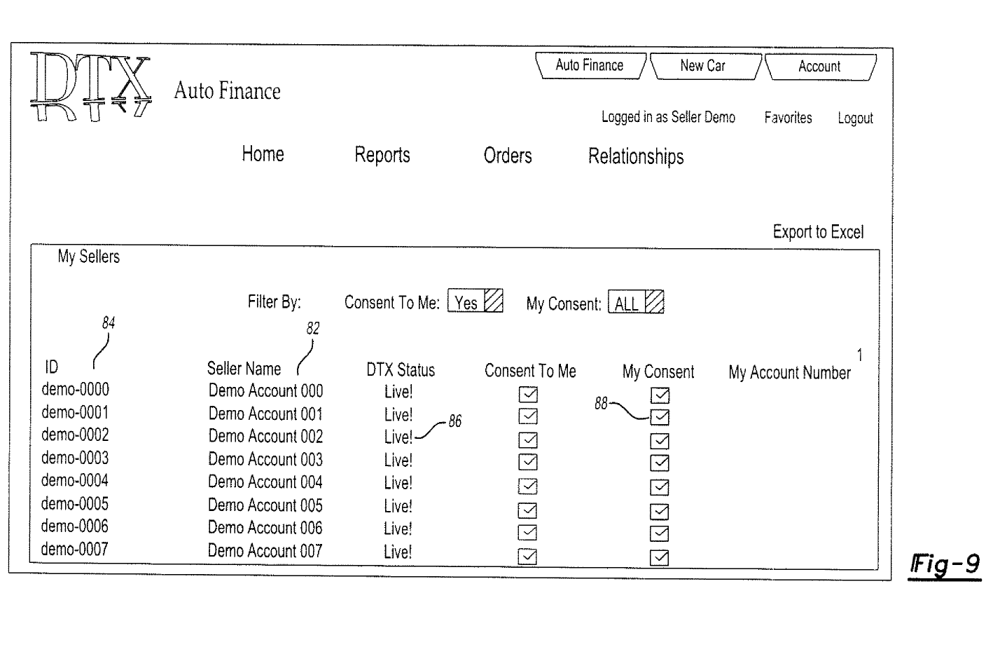

Referring now to FIG. 9, each buyer may also create customized relationships with particular sellers so that sale lead information is, or is not accepted from particular sellers on the exchange. Specifically, as shown in FIG. 7, each buyer account includes a listing 82 of each seller who also has an account on the exchange and a link 84 to each seller's personal profile. This same list may also indicate whether the seller is currently active 86 on the exchange. Using a check box 88 associated with each seller account, each buyer may then indicate whether that buyer will consent to accept lead offers from a particular seller. If a buyer does not agree to a particular seller, any new lead information that is subsequently submitted to the exchange from that seller will not be offered to the buyer. If a buyer does agree to a particular seller, and that seller also agrees to accept offers from the seller, then lead information that is subsequently submitted to the exchange administrator 12 by the seller will be offered to that particular buyer (and all other consenting buyers to whom the seller has also consented).

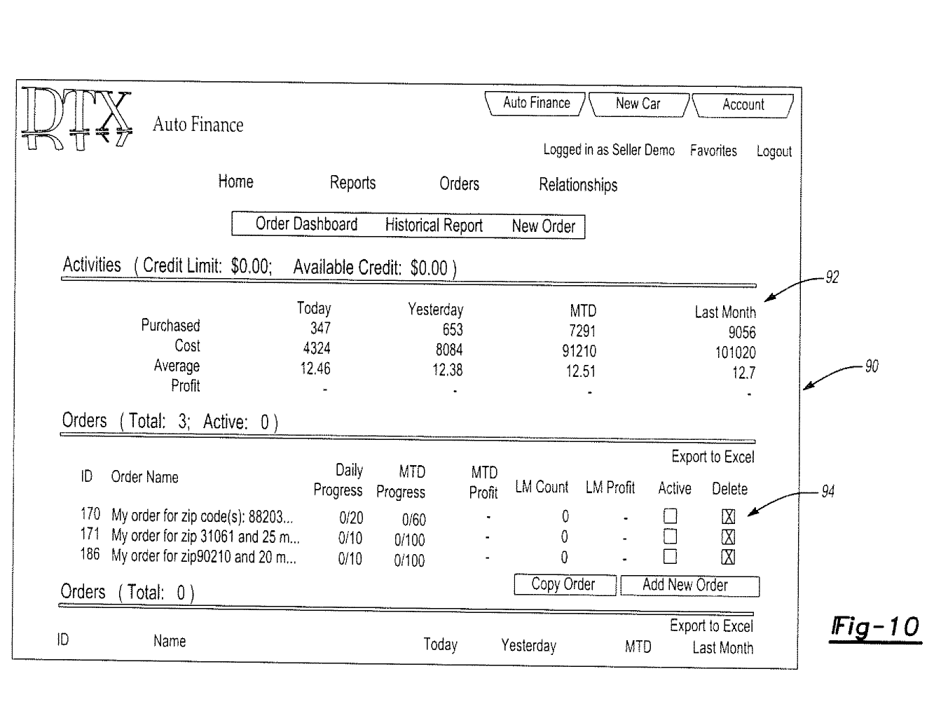

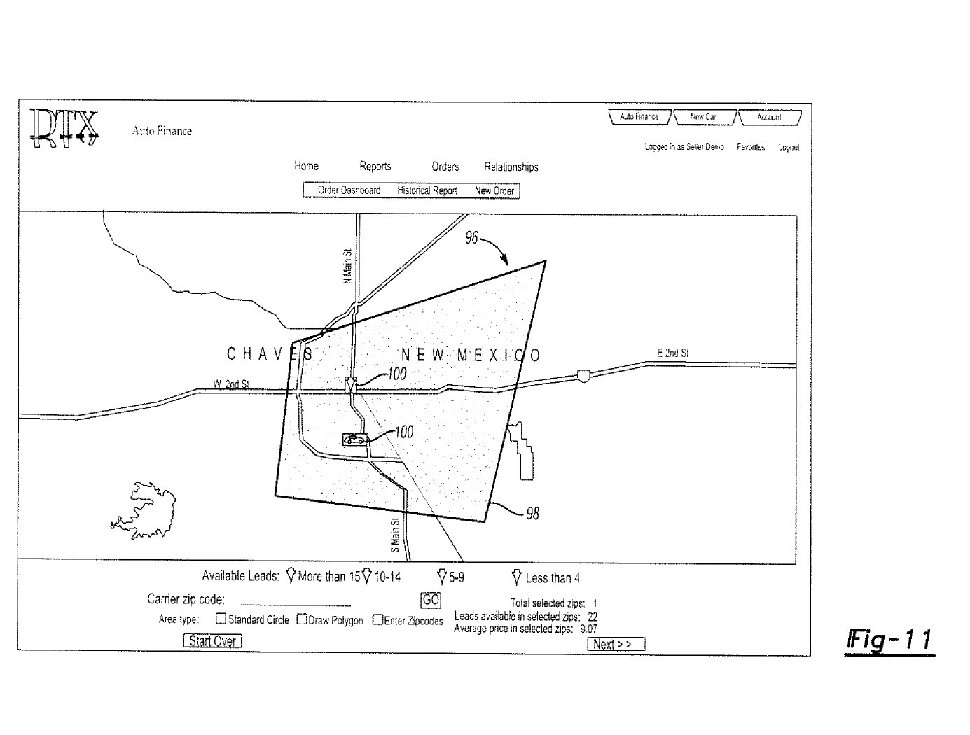

Referring now to FIGS. 10-14, a buyer may place a market order with the exchange administrator 12 to facilitate automatic bidding by the buyer on new sales lead information as the information is submit to the exchange administrator 12. Specifically, as shown in FIG. 10, each buyer account may include an order interface 90 that may have a purchase summary 92 (similar to that on the overview—FIG. 8) and a list of standing market orders 94. To establish a market order (see e.g., order ID 170 on FIG. 10), a buyer must first select a particular geographic area 96 of the nation from which the buyer is interested in purchasing lead information. As best shown in FIG. 11, the selected geographic area may be defined using either: 1) a circle of a predetermined area (e.g., 5 miles) around the center of a particular postal ZIP code; 2) a polygon 98 drawn by the buyer (See FIG. 11); or 3 the area of one of more ZIP codes. FIG. 11, for example, shows a geographic area drawn/overlaid over a virtual map of the earth (e.g., Microsoft Virtual Earth) in the area of Roswell, N. Mex. Once the geographic area has been selected, the selected area may be populated with graphical icons 100 representing the number of leads within each ZIP code within the selected area are presently available for bidding though in the exchange administrator 12.

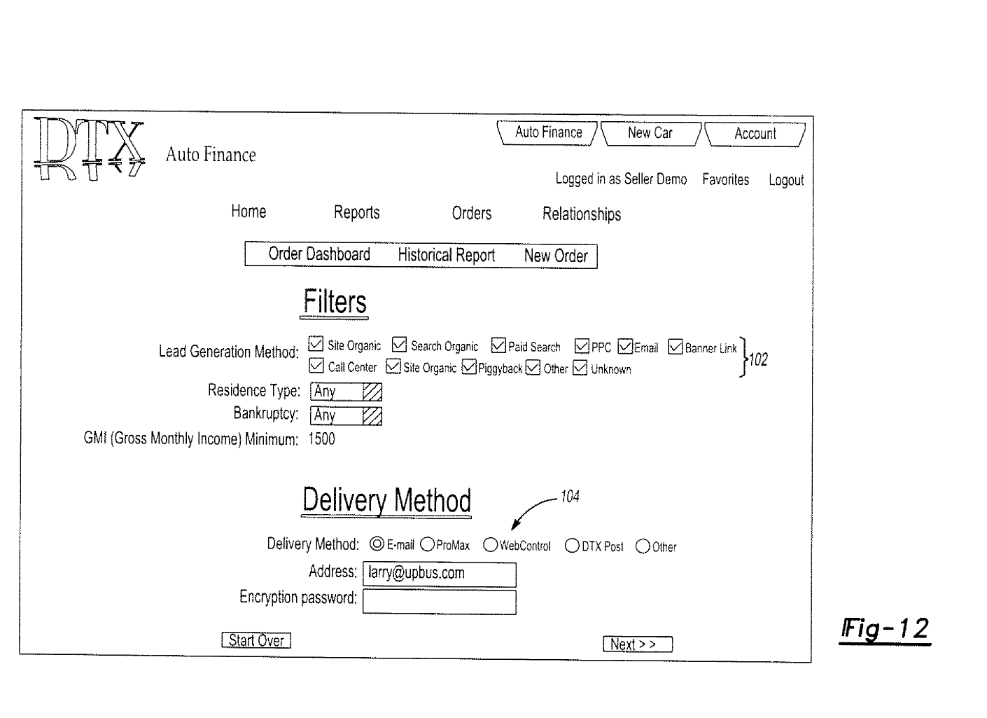

Still referring to FIGS. 10-14, after selecting a geographic area a buyer may select one or more market order filters 102. As shown in FIG. 12, the filters 102 may allow a buyer to designate leads for possible bid based upon the manner in which the lead was generated. A non-exclusive list of such filters includes: 1) the lead's residence type; 2) whether the lead is in bankruptcy; 3) the lead's minimum gross monthly income; 4) and the nature of the initial contact for the lead (i.e., email, clicking a webpage banner link, via a call center, via a website, etc.). A buyer may also identify the means 104 by which the buyer would like to be contacted concerning potential leads (e.g., email, etc.).

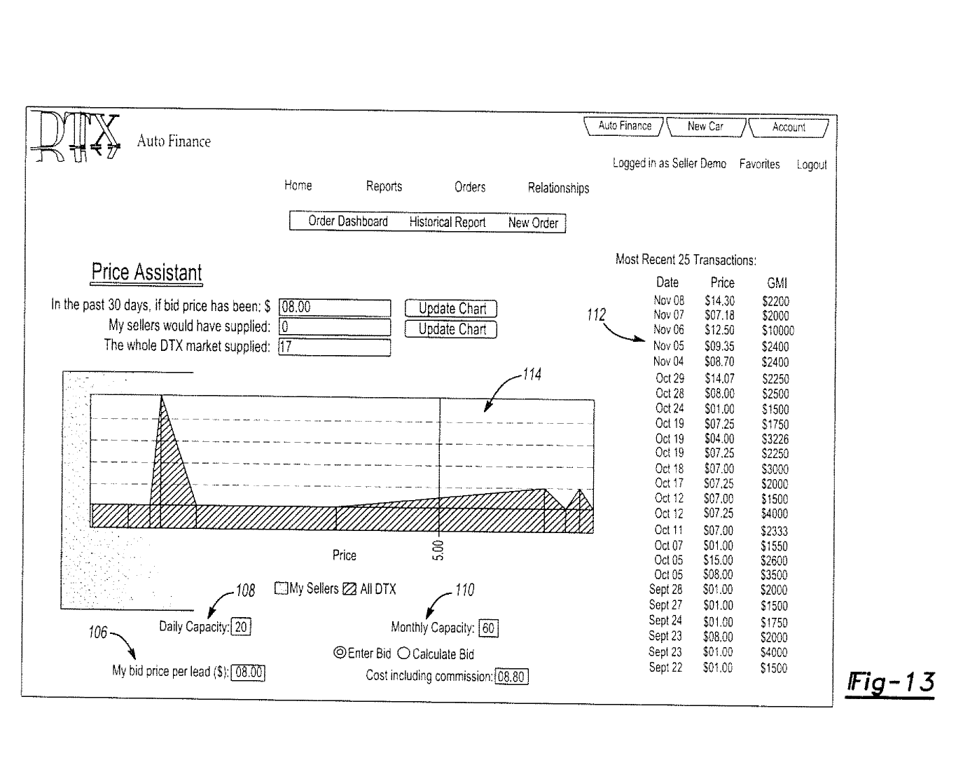

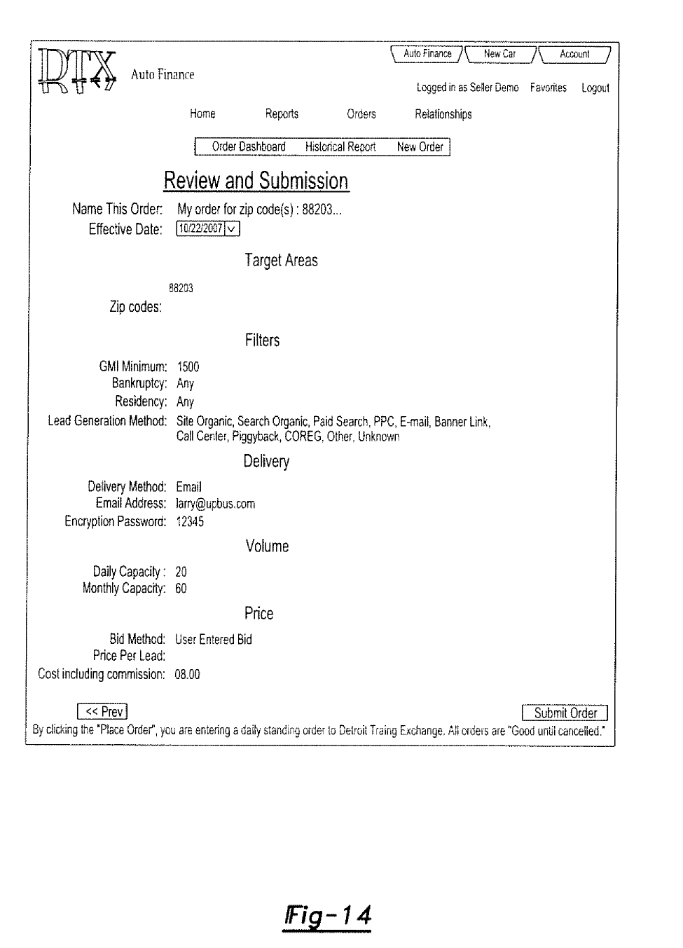

Still referring to FIGS. 10-14, in a next step, a buyer may set the buyer's specific bid price 106 for sales lead information under to the market order, and the maximum number of leads the buyer might wish to purchase at the price on a 1) daily 108 and 2) monthly basis 110. For example, as shown in FIG. 13, a buyer may select a bid price 106 of $8.00 per lead, with a maximum 108 of 20 successful lead bids/purchases per day and a monthly 110 maximum of 60 successful lead bids/purchases. To assist the buyer in setting a particular bidding rate, the buyer may be provided with historical pricing information 112 for sales lead information and a related graphical interface 114 that details how many leads, on average, the buyer might have purchased had the buyer set his or her bid rate at a predetermined rate. As a further step (FIG. 14) in the market order process, a buyer may review the market order information and submit the order to the exchange administrator 12. As will be described further below, once a market order has been submitted the exchange administrator 12 may continue to automatically bid on new sales lead information that meets the buyer's market order requirements (at the rate set by the buyer) as that sale lead information is submitted to the exchange.

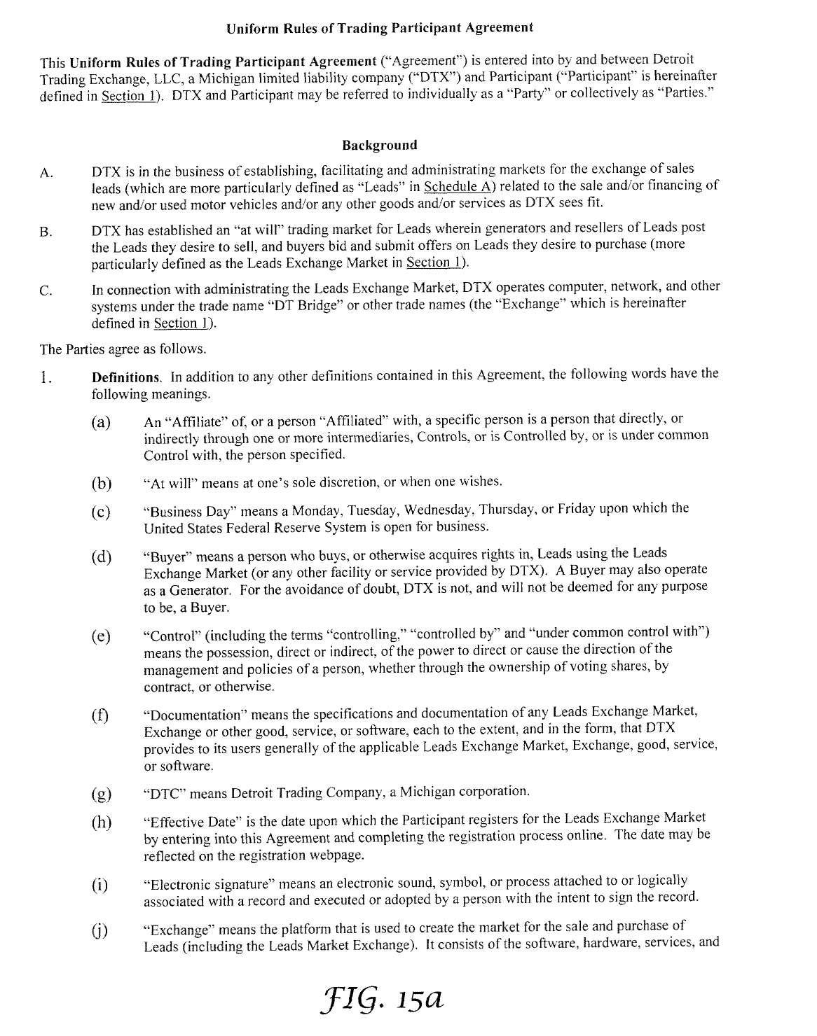

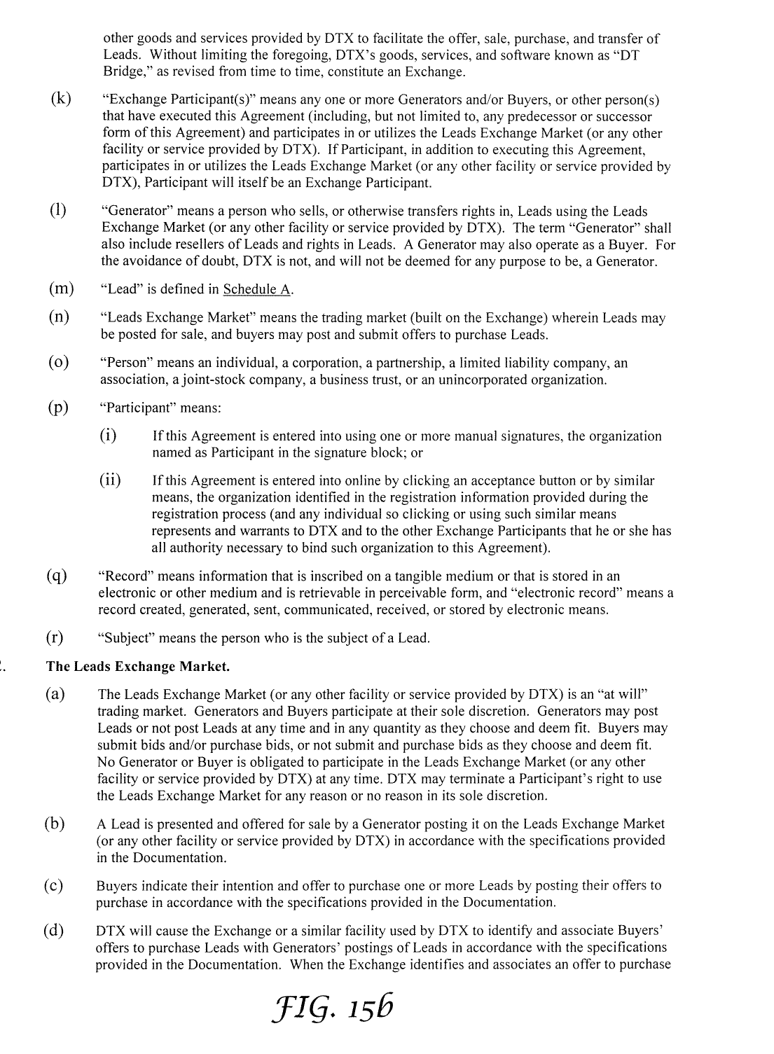

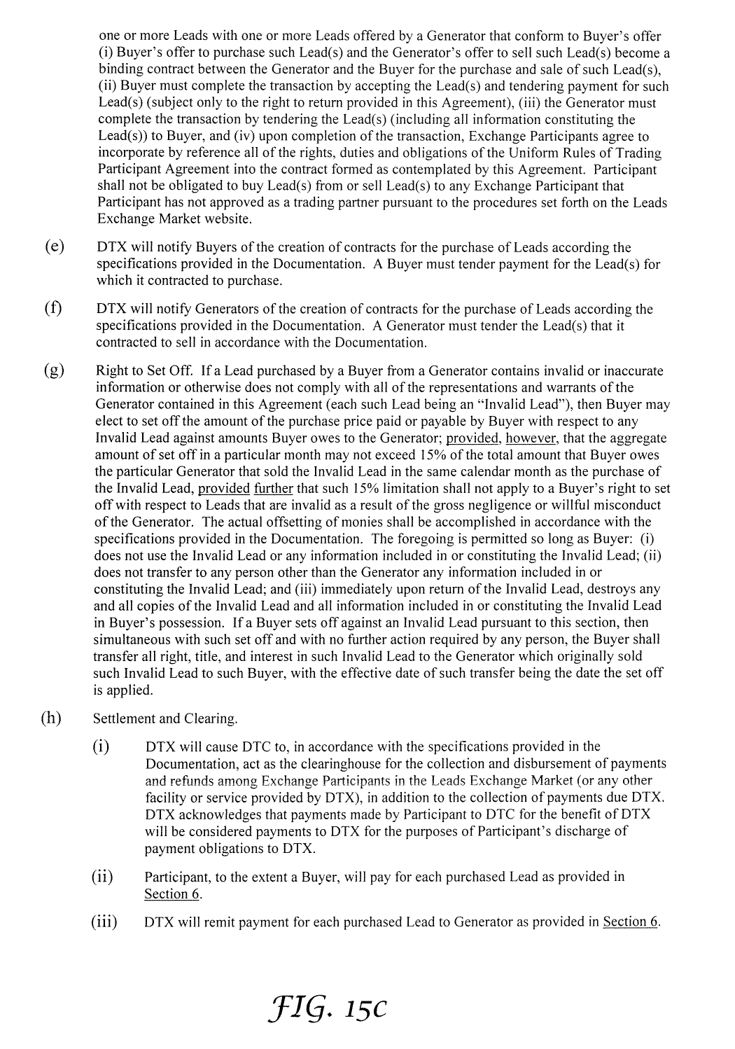

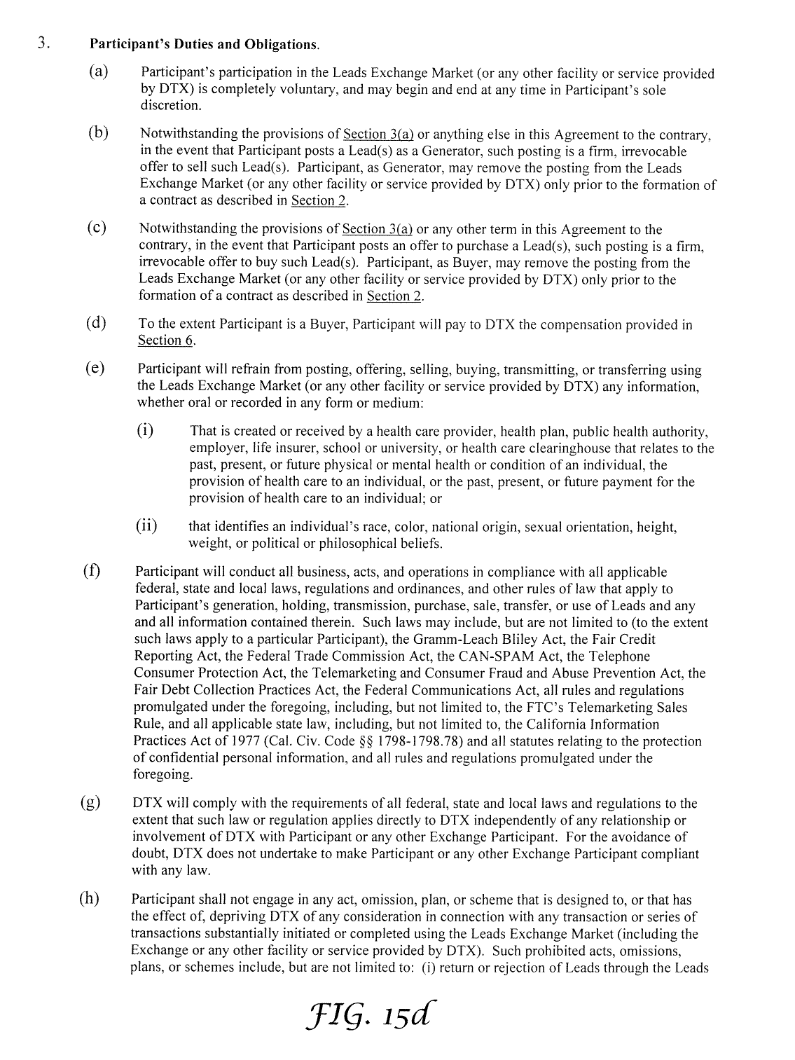

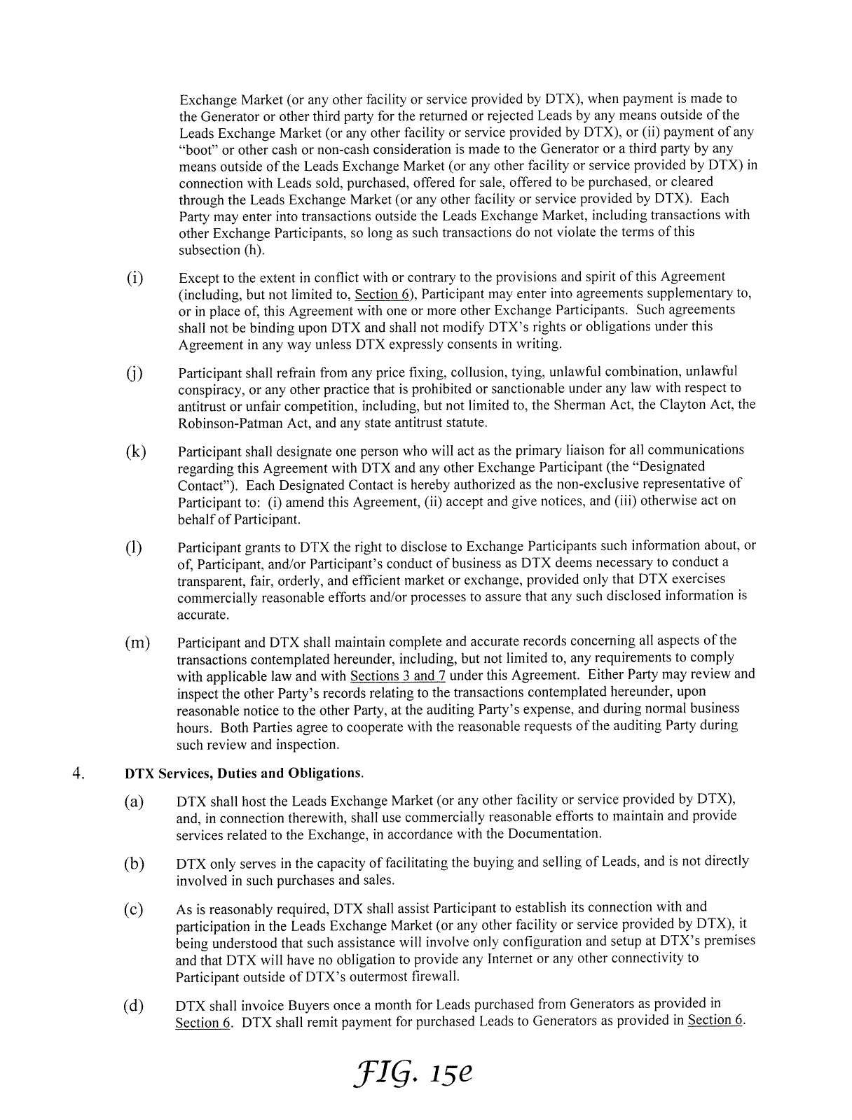

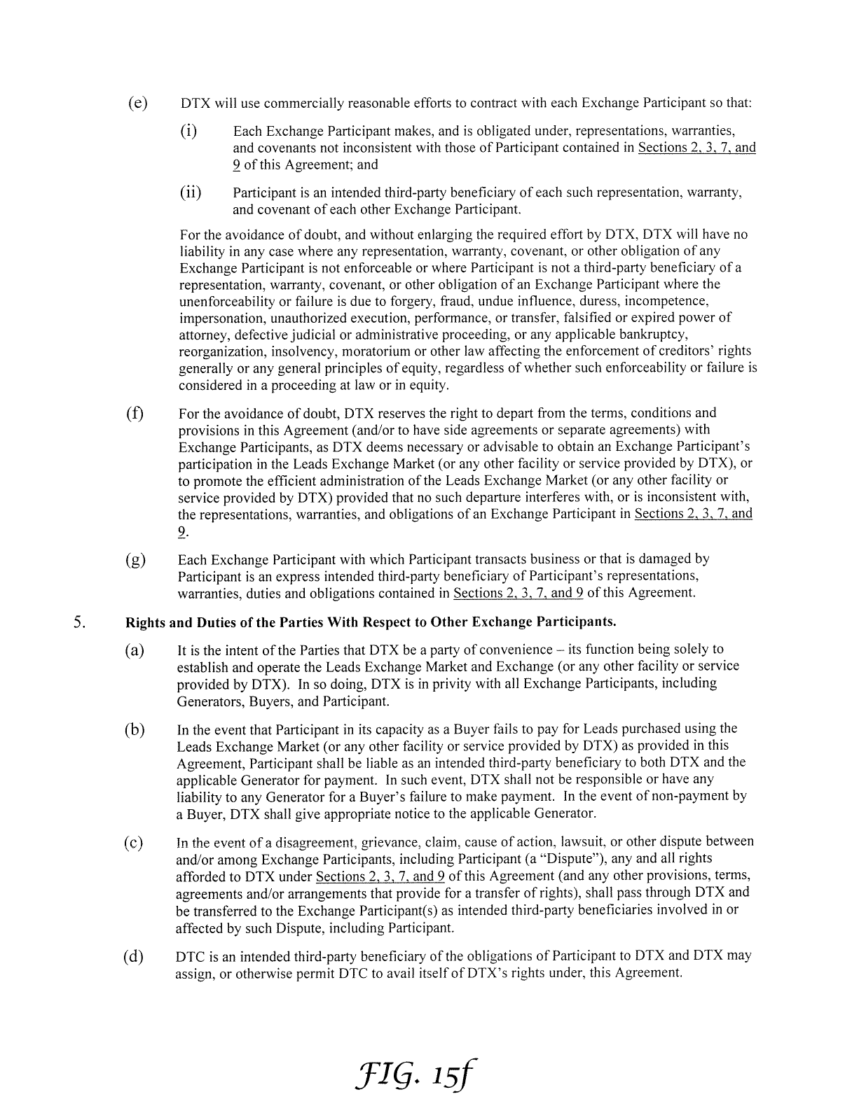

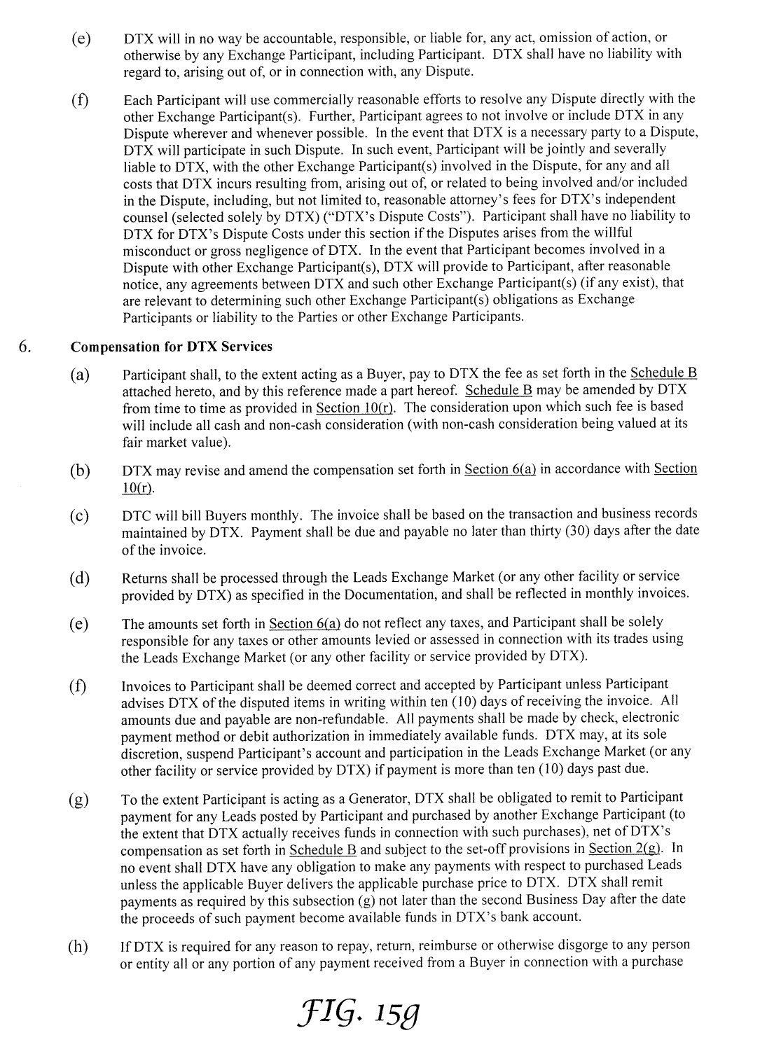

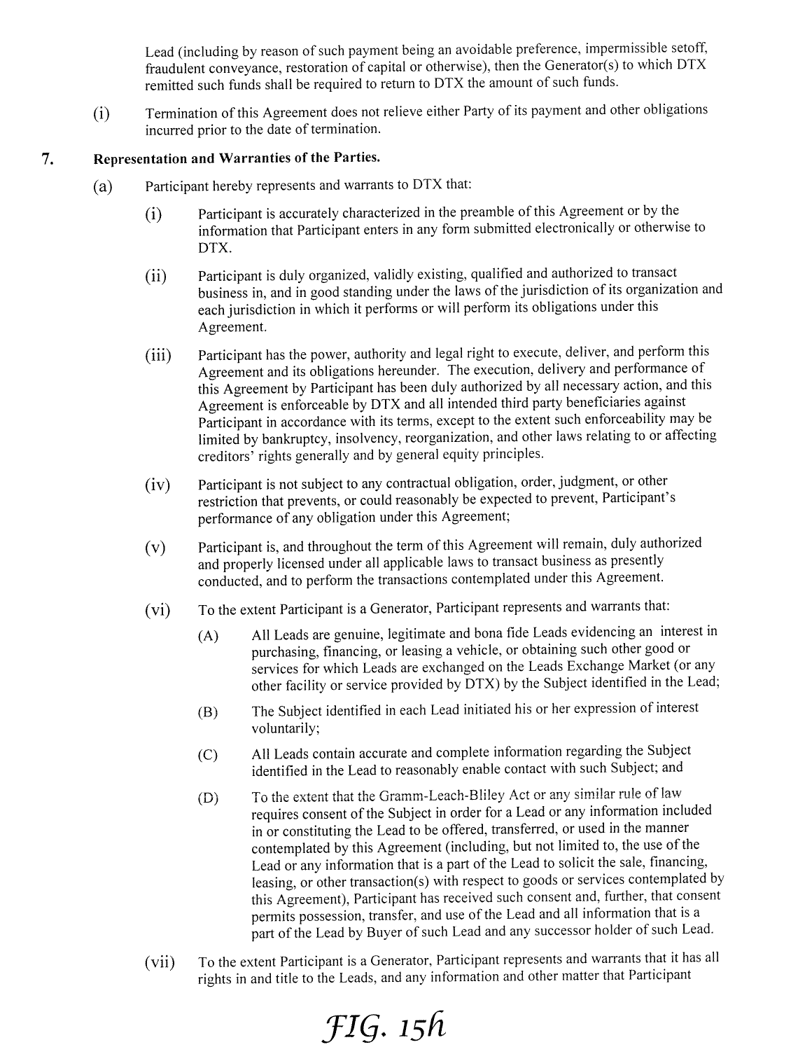

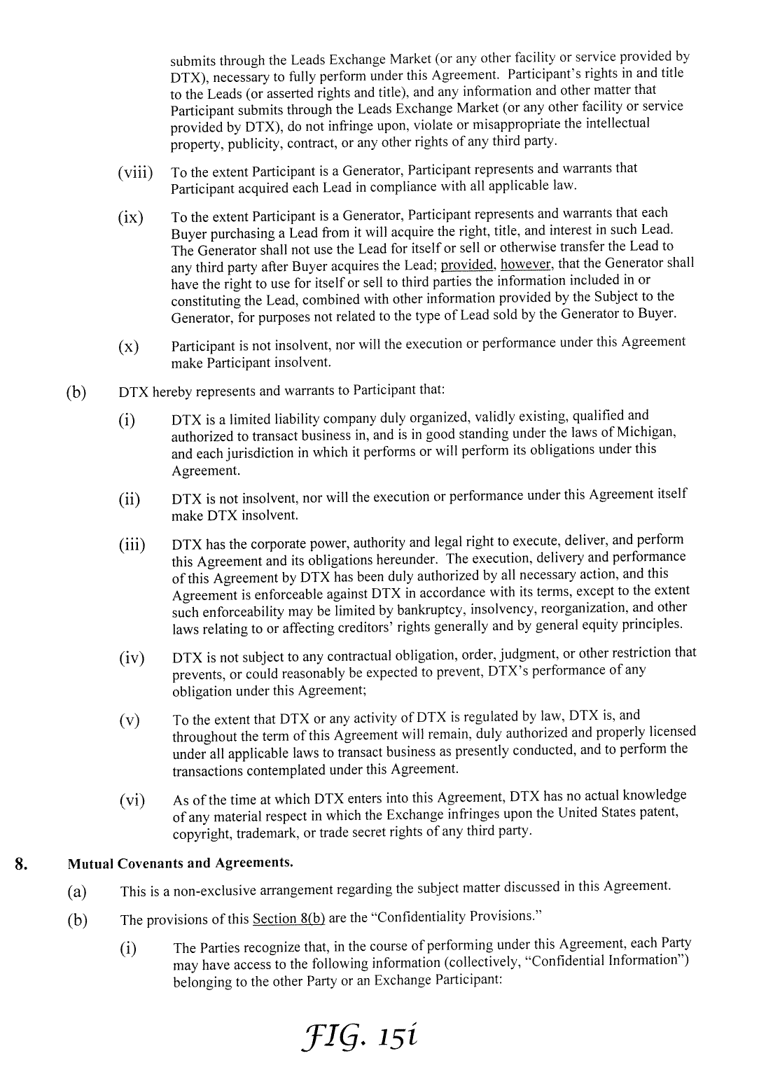

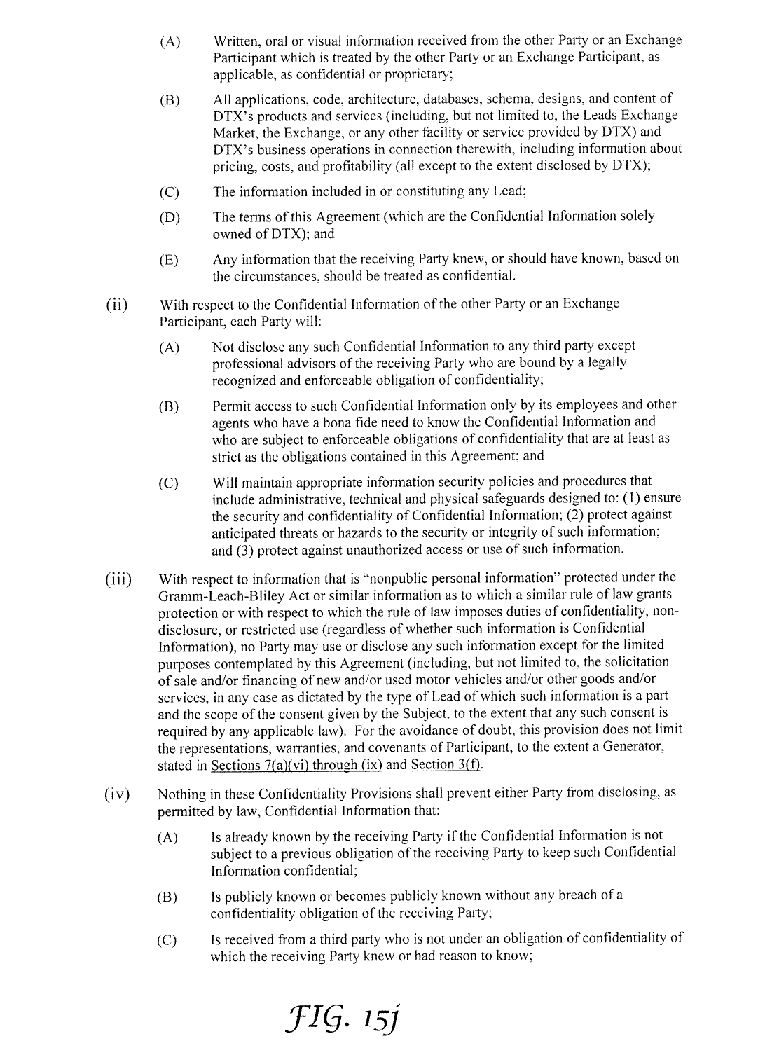

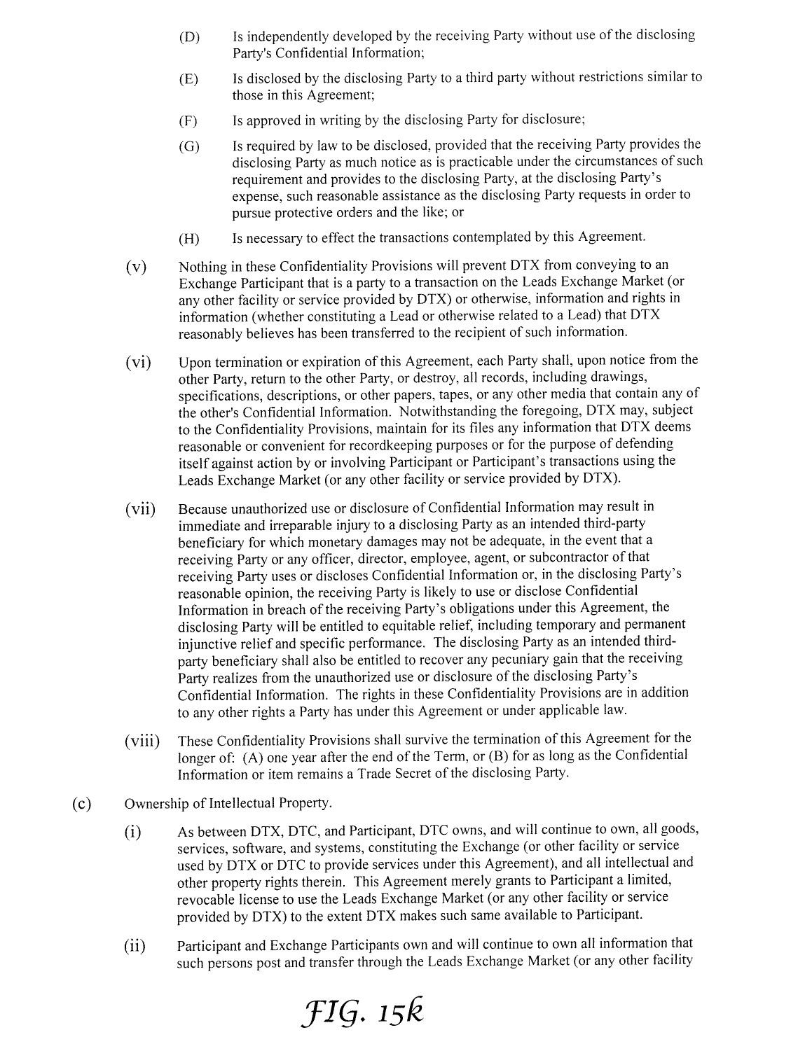

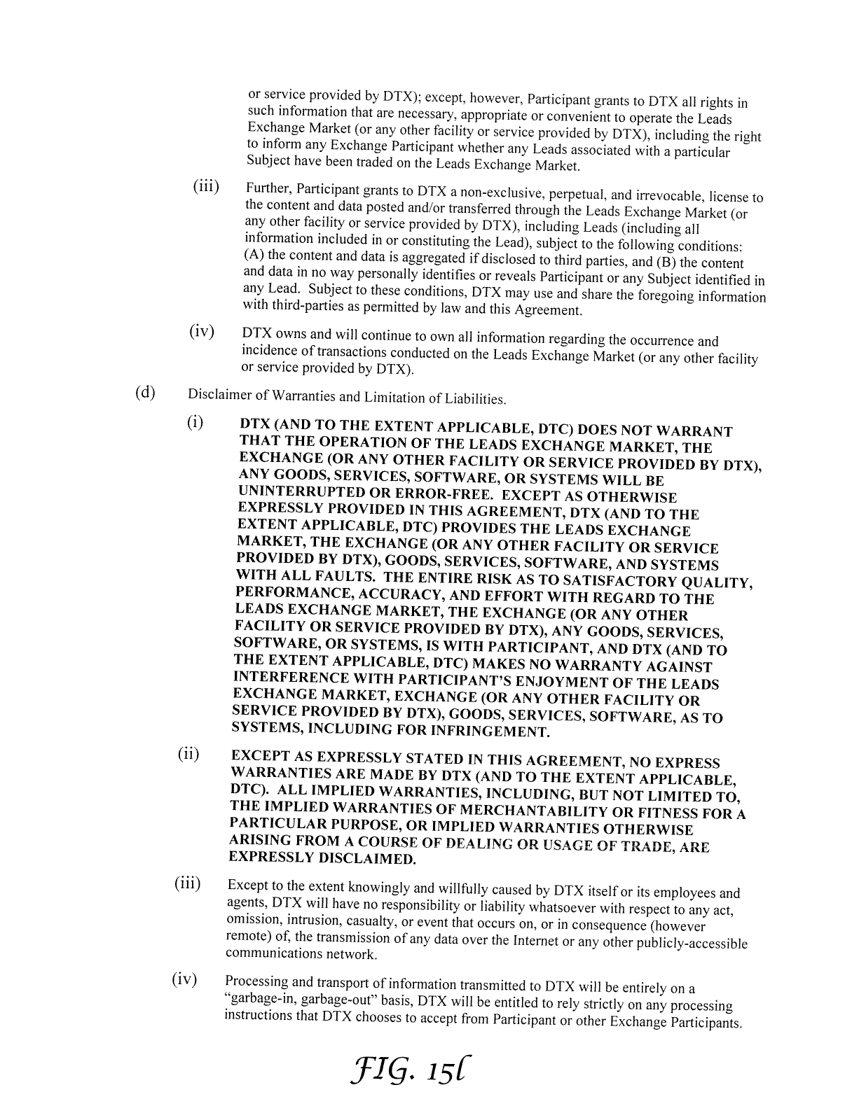

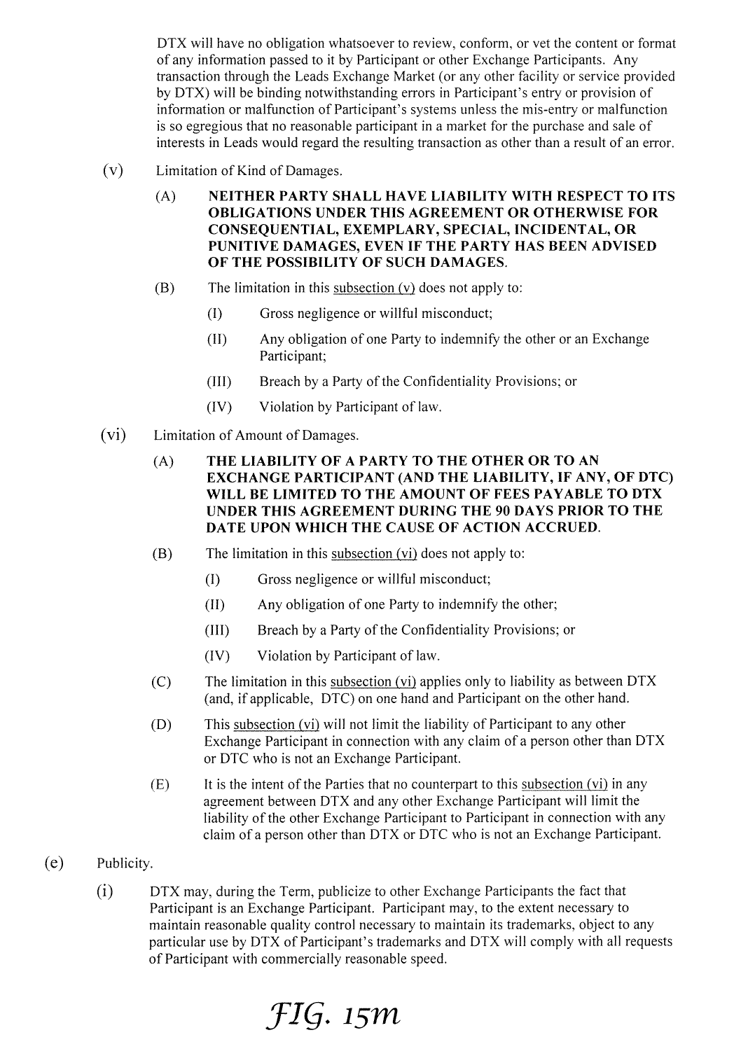

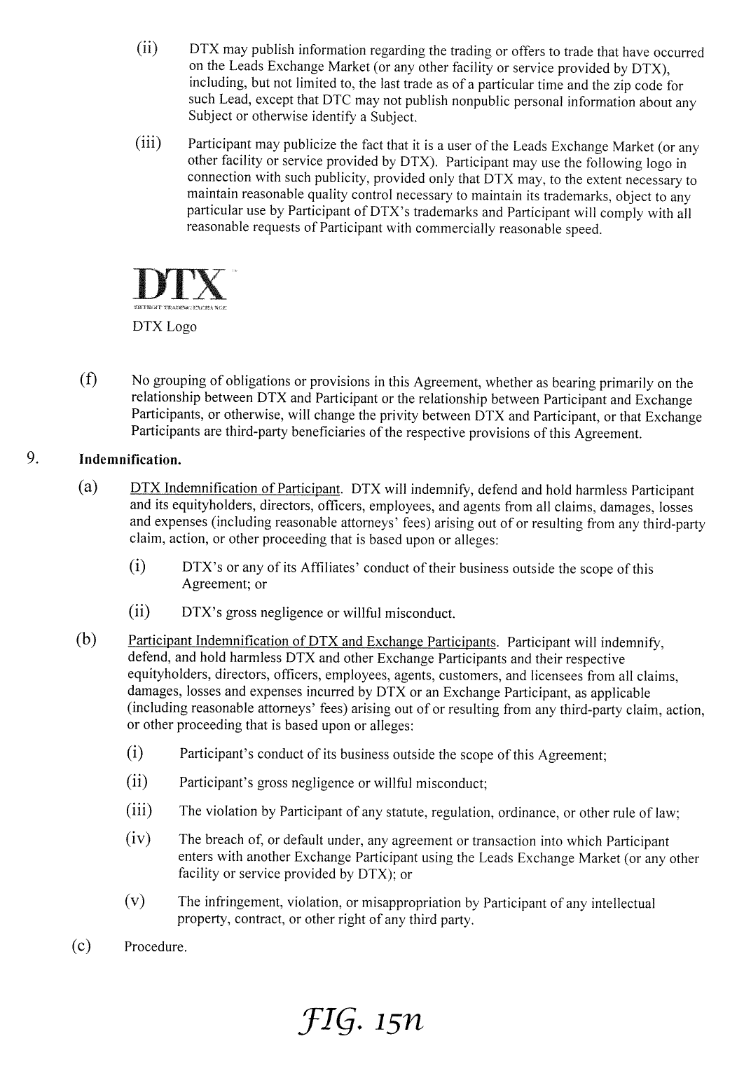

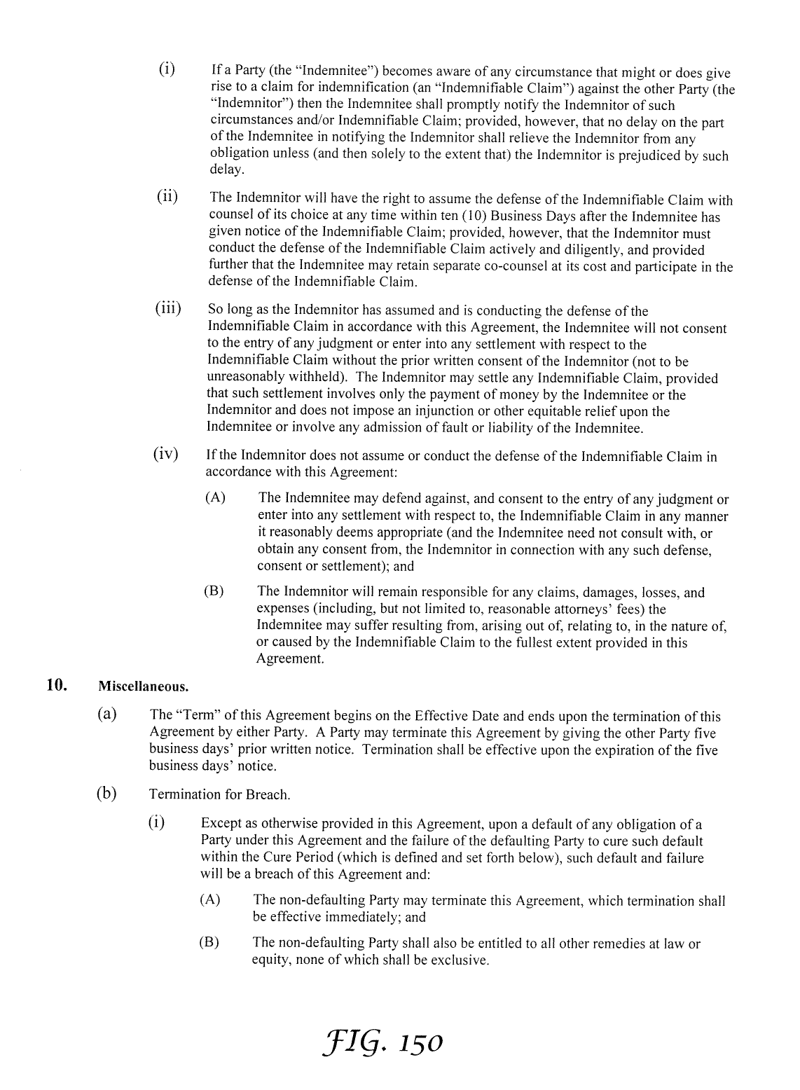

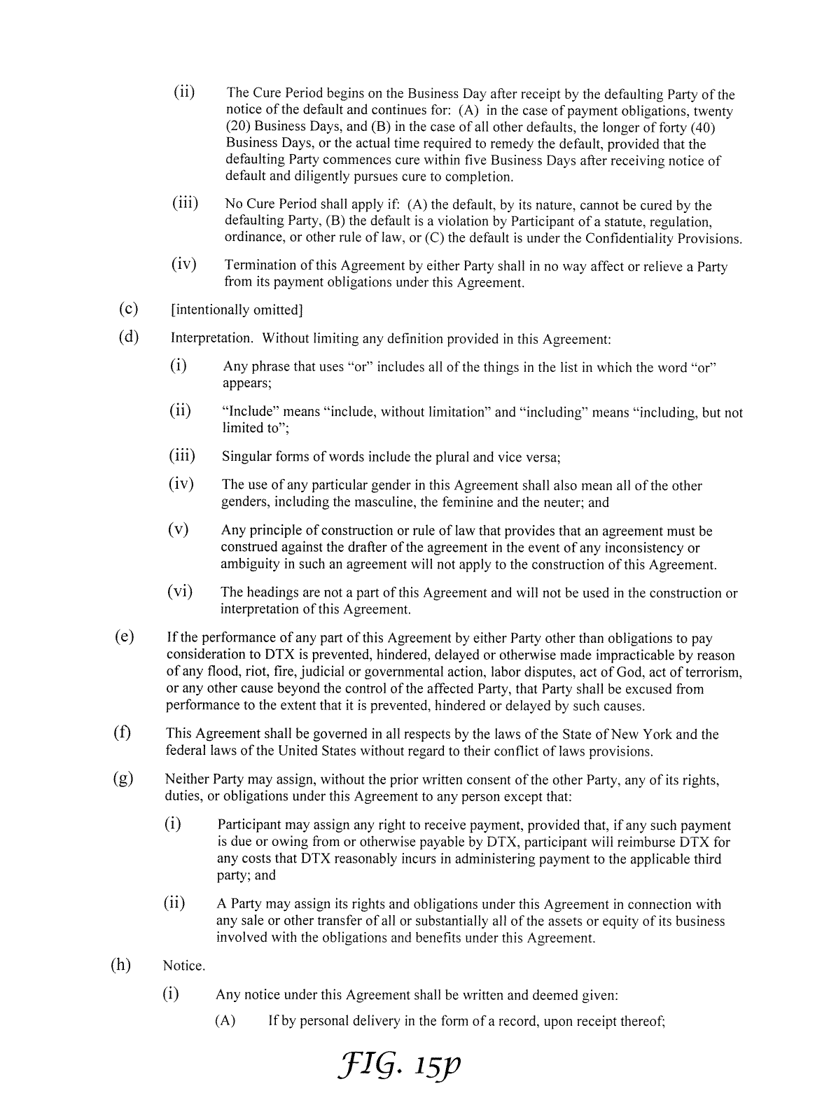

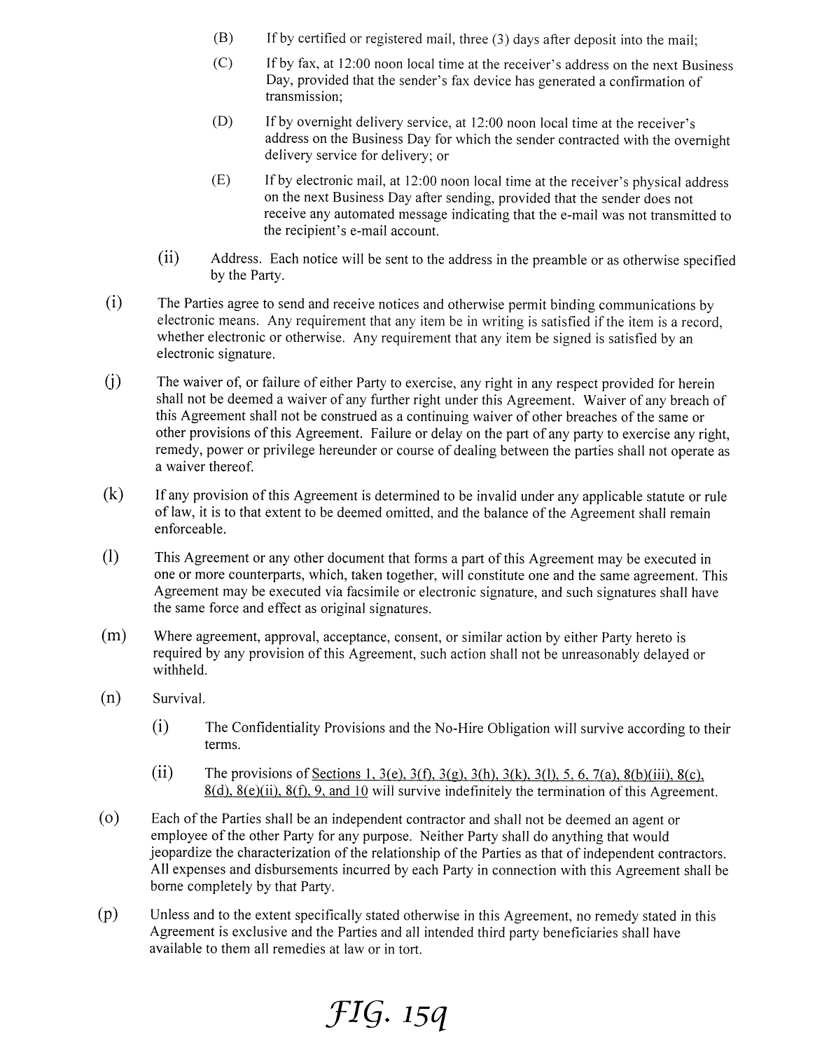

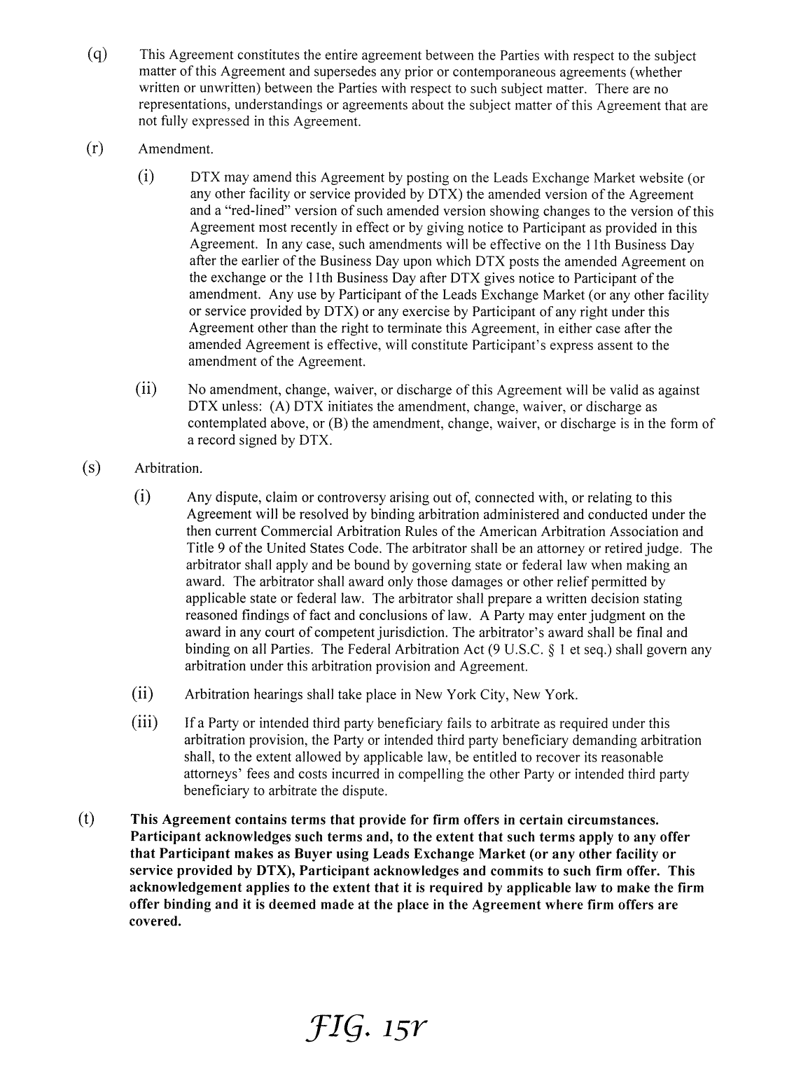

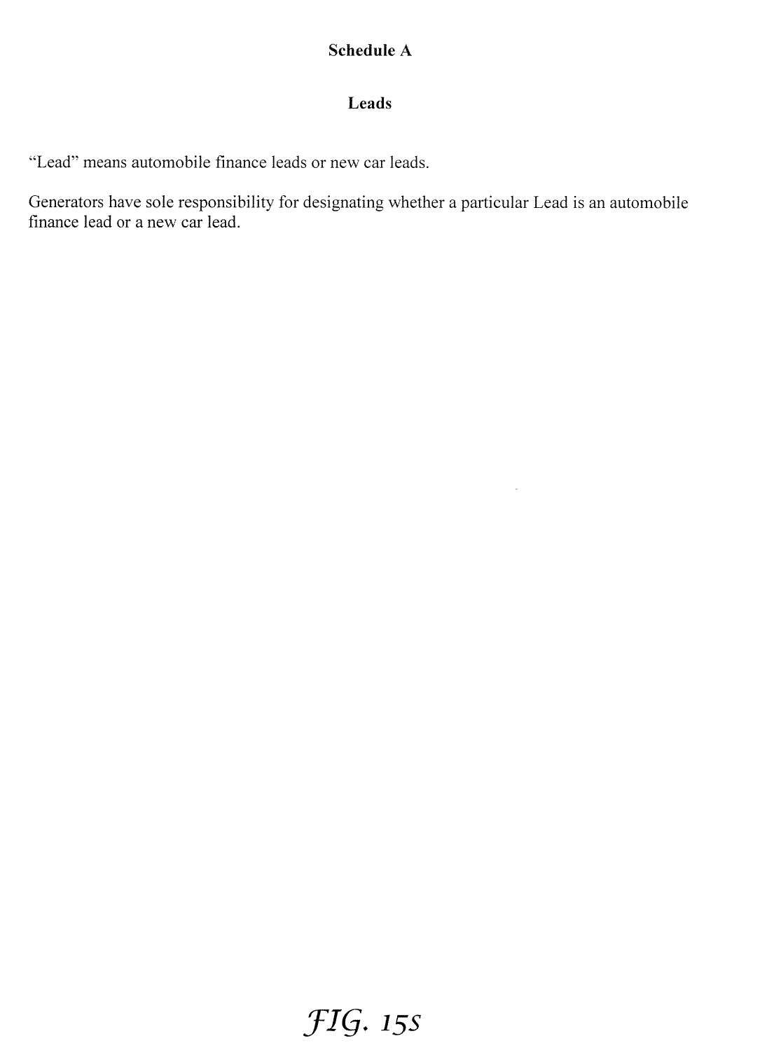

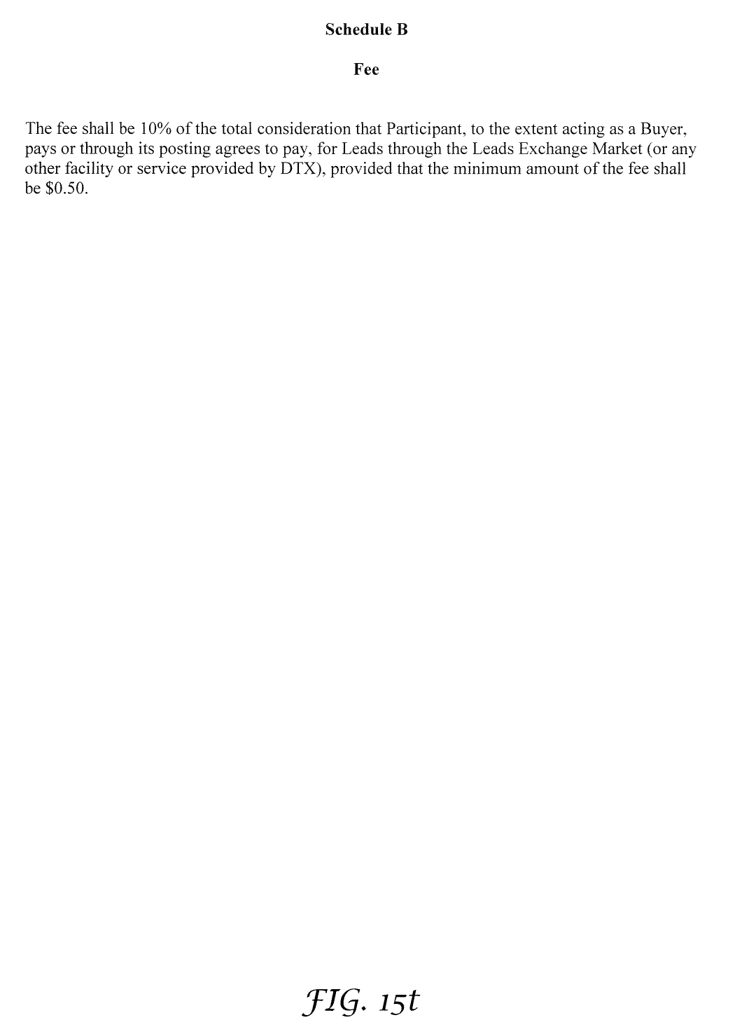

Referring now to FIGS. 15a-15t, when a buyer or seller joins the exchange and secures an account, they may agree to be bound by Uniform Rules of Trading. These Uniform Rules of Trading may require that the parties agree to have the price determined by the automated administrator's matching process as described below.

Still referring to FIGS. 15a-15t, the market for sale lead information may be volatile and time sensitive. The Uniform Rules of Trading permit sale lead information to be listed and sold in seconds or minutes. Specifically, the Uniform Rules of Trading permit the sellers/generators and buyers/aggregators of sale lead information to join the system as third party beneficiaries—without the need for independent contracts for each transaction or contracts between a specific seller and a specific buyer. Thus, the Uniform Rules of Trading may facilitate a market with many buyers and sellers wherein all participants agree to the same terms, participation is open, and transactions may be made rapidly. Each participant may sign the Uniform Rules of Trading document only once to have full range of participation. As mentioned above, each participant may also have the right to do business or not with the other participants. The price is not specified in the Agreement but is determined at the time of the transaction. This enables dynamic pricing and eliminates the needs for addendums.

Referring again to FIG. 1, in operation the system utilizes the exchange administrator 12, which acts as the exchange mechanism for the sale lead information. The lead sellers/generators submit new sales lead information to the exchange administrator 12. As mentioned above, the new sales lead information may be collected and transmitted (e.g., “SELLGX” or “DTX Place”) to the exchange administration directly, or via a number of third party portals 26, 28, 30 (e.g., DT Agent). Once received, the exchange administrator 12 may then deliver a selected portion of the sales lead information in the form of an electronic message or “PING” to all consenting buyers with whom the seller had previously established a trading relationship. Specifically, the exchange administrator 12 may forward the “PING” directly to buyers' accounts on the exchange administrator 12 and/or to a buyer's external software platform (e.g., DT Agent). The sales lead information included within the “PING” may be limited to a lead's ZIP code, their gross monthly income, a portion of their social security number and historical sales data showing the price at which the last three sales leads in the same ZIP were sold. Although, it will be anticipated that the information contained in the “PING” may be enhanced to include additional information to a bidder. This additional information may indicate, for example, how the lead was generated or whether it has been previously sold. Further, it will be appreciated that each sellers/generators may also have the option to sell the sale lead information at market price, which is the highest bid received within a time period, or to set a minimum price for the lead. If a number of responses from buyers are received above the minimum price, a sale may be made to the highest bidder. A payment, including a commission for the exchange administrator 12, for each successful bid may also be processed by the exchange administrator 12 by either 1) an electronic funds transfer from a buyer's account with a third party financial institution; or 2) the transfer of funds buyer funds that are held in a buyer's escrow controlled by the exchange administrator 12.

After the sale lead information “PING” has been delivered to all buyers with whom the seller previously established a relationship, the exchange administrator 12 may then wait for a predetermined amount of time (e.g., a few seconds to several minutes) to receive bids from the various buyers. Bids from buyers may be placed with the exchange administrator 12 using, for example, the market order feature described above, or directly using a third party software platform (e.g., DT Agent or DTX Bridge).

After the predetermined amount of time has elapsed, the exchange administrator 12 may evaluate all the received bids and identify the best match relative to the criteria set by the seller, which is often the highest price. Having determined the best bid, the complete sales lead information the exchange administrator 12 may then “POST” (see FIG. 1—POST or POSTXB) the sale lead information to the selected highest bidding buyer allowing the buyer to immediately utilize the sales lead information. If no suitable offer is made within the predetermined amount of time, which is usually no more than several seconds or at most a few minutes, the sale lead information may be returned to the seller/generator. In this way all participants (buyers and sellers) have total control over the terms of each transaction.

Having thus described the disclosed embodiment of a system and method for the exchanging/trading of sales leads, various other embodiments will become apparent to those having skill in the art that do not depart from the scope of the claims set forth below:

I claim:

1. A method for exchanging lead information comprising the steps of:
providing uniform trading rules for the exchange of lead information;
providing an exchange administrator having a plurality of seller accounts, a plurality of buyer accounts and operating to receive, process and transmit lead information between the buyer account and the seller account, the seller and buyer accounts each being subject to the uniform trading rules;
receiving lead information into one of the plurality of seller accounts;
transmitting a portion of the lead information to at least one of the plurality of buyer accounts;
receiving a bid for the purchase of the lead information from at least one of the plurality of buyer accounts;
transferring the lead information from the seller account to one of the plurality of buyer accounts in response to a successful bid by the buyer account.

2. The method for exchanging lead information of claim 1 further comprising the steps of providing in one of the plurality of seller accounts a list of buyer accounts on the exchange administrator; and selecting buyer accounts to which a portion of the lead information will be transmitted.

3. The method for exchanging lead information of claim 1 further comprising the steps of providing in one of the plurality of buyer accounts a list of seller accounts on the exchange administrator; and selecting seller accounts from which the buyer account agrees to accept a transmission of a portion of the lead information.

4. The method for exchanging lead information of claim 1 wherein the step of transmitting a portion of the lead information to the buyer account comprises transmitting a ZIP code, gross monthly income and a portion of social security number for the lead.

5. The method for exchanging lead information of claim 1 further comprises the set of creating a market order on at least one of the plurality of buyer accounts.

6. The method for exchanging lead information of claim 5 wherein the step of receiving a bid for the purchase of the lead information from at least one of the plurality of buyer accounts comprises receiving a bid from a market order associated with one of the plurality of buyer accounts.

7. The method for exchanging lead information of claim 5 wherein the step of creating a market order comprises the step of selecting a geographic area of the nation from which a buyer is interested in obtaining lead information.

8. The method for exchanging lead information of claim 5 wherein the step of creating a market order comprises the step of creating a filter to identify lead information for possible bid based upon the manner in which the lead was generated.

9. The method for exchanging lead information of claim 5 wherein the step of creating a market order comprises the step of setting a bid price for sales lead information.

10. The method for exchanging lead information of claim 5 wherein the step of creating a market order comprises identifying a maximum number of new lead information a buyer shall successfully bid upon each day.

11. The method for exchanging lead information of claim 5 wherein the step of creating a market order comprises identifying a maximum number of new lead information a buyer shall successfully bid upon each month.

12. A system for exchanging lead information comprising:
(a) a lead exchange administrator having a data processor and data storage means, the data storage means including a seller account and a buyer account;
(b) first means for receiving lead information into a seller account;
(c) second means for transmitting a portion of the lead information to the buyer account;
(d) third means for receiving a bid for the purchase of the lead information from the buyer account;
(e) fourth means transferring the lead information from the seller account to the buyer account in response to a successful bid by the buyer account;
(f) fifth means for mandating that a buyer and seller exchange leads in accordance with a set of uniform trading rules.

13. The method for exchanging lead information of claim 12 further comprising means for generating a market order on at least one of the plurality of buyer accounts.

14. The method for exchanging lead information of claim 13 wherein means for receiving a bid for the purchase of the lead information from the buyer account comprises means for receiving a bid from a market order associated with one of the plurality of buyer accounts.

15. The method for exchanging lead information of claim 13 wherein the means for generating a market order comprises means for selecting a geographic area of the nation from which a buyer is interested in obtaining lead information.

16. The method for exchanging lead information of claim 13 wherein the means for generating a market order comprises means for creating a filter to identify lead information for possible bid based upon the manner in which the lead was generated.

17. The method for exchanging lead information of claim 13 wherein the means for generating a market order comprises means for setting a bid price for sales lead information.

18. The method for exchanging lead information of claim 13 wherein the means for generating a market order comprises means for identifying a maximum number of new lead information a buyer shall successfully bid upon each day.

19. The method for exchanging lead information of claim 13 wherein the means for generating a market order comprises means for identifying a maximum number of new lead information a buyer shall successfully bid upon each month.

20. A method for exchanging lead information comprising the steps of:
providing uniform trading rules for the exchange of lead information;
providing an exchange administrator operating to receive, process and transmit lead information between a lead aggregator and a lead generator, the lead aggregator and generator each being subject to the uniform trading rules;
providing a data formatting means for receiving lead information and formatting the lead information from a first format readable by a first terminal into a second format readable by a second terminal;
receiving lead information from a lead generator into the exchange administrator through the data formatting means;
transmitting a portion of the lead information out of the exchange administrator through the data formatting means to a lead aggregator;
receiving in exchange administrator and through the data formatting means a bid from a lead aggregator for the purchase of the lead information;
transmitting the lead information out of the exchange administrator and to the lead aggregator in response to a successful bid by the lead aggregator.
